(19) United States
(12) Patent Application Publication
(10) Pub. No.: US 2026/0353154 A1
(43) Pub. Date: Nov. 5, 2026

(54) METHOD AND APPARATUS FOR MODEL MONITORING DURING CHANNEL STATE INFORMATION FEEDBACK IN COMMUNICATION SYSTEM

(71) Applicant: ELECTRONICS AND TELECOMMUNICATIONS RESEARCH INSTITUTE, Daejeon (KR)

(72) Inventors: Youngjoon YOON, Daejeon (KR); Yong Jin KWON, Daejeon (KR); Seungjae BAHNG, Daejeon (KR); Anseok LEE, Daejeon (KR); Heesoo LEE, Daejeon (KR); Yunjoo KIM, Daejeon (KR); Hyun Seo PARK, Daejeon (KR); Jungsook BAE, Daejeon (KR); Jungbo SON, Daejeon (KR); Yu Ro LEE, Daejeon (KR)

(73) Assignee: ELECTRONICS AND TELECOMMUNICATIONS RESEARCH INSTITUTE, Daejeon (KR)

(21) Appl. No.: 19/661,365

(22) Filed: Apr. 28, 2026

(30) Foreign Application Priority Data
Apr. 29, 2025 (KR) 10-2025-0056200
Apr. 30, 2025 (KR) 10-2025-0057722
Apr. 17, 2026 (KR) 10-2026-0069992

(51) Int. Cl. H04W 24/10; H04B 7/06; H04B 17/373; H04B 17/391

(52) U.S. Cl. CPC H04W 24/10; H04B 7/0626; H04B 17/373; H04B 17/3913

(57) ABSTRACT

A method of a terminal may comprise: receiving, from a base station, a reporting instruction for performance metrics; determining a first performance metric based on first channel state information (CSI) at a first time and second CSI predicted for the first time; determining a second performance metric based on the first CSI and third CSI at a second time; and transmitting, to the base station, the first performance metric and the second performance metric according to the reporting instruction.

### CROSS-REFERENCE TO RELATED APPLICATIONS

This application claims priority to Korean Patent Applications No. 10-2025-0056200, filed on Apr. 29, 2025, No. 10-2025-0057722, filed on Apr. 30, 2025, and No. 10-2026-0069992, filed on Apr. 17, 2026, with the Korean Intellectual Property Office (KIPO), the entire contents of which are hereby incorporated by reference.

### BACKGROUND

### 1. Technical Field

The present disclosure relates to a technique for model monitoring during channel state information feedback, and more particularly, to a model monitoring technique for monitoring artificial intelligence (AI)/machine learning (ML) model when channel state information is predicted by a terminal of a communication system.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

In such a communication system, a terminal may use intelligent technologies (e.g. artificial intelligence (AI)/machine learning (ML)) at a radio interface for beam management, positioning accuracy enhancement, channel state information (CSI) feedback enhancement, and the like. When the terminal performs CSI prediction using an AI/ML model at the terminal side, the AI/ML model may require continuous performance monitoring in order to maintain model accuracy and operational reliability. When prediction performance of the AI/ML model is degraded due to a specific environmental change, continued use of the AI/ML model may rather degrade overall system performance. More specifically, when model-based CSI prediction is continuously performed in a state in which performance degradation of the AI/ML model occurs, predicted CSI may not accurately match an actual channel state, and thus inaccurate results may be generated. Such inaccurate CSI may not only fail to solve a channel aging problem, but may also cause a reduction in system throughput due to provision of incorrect channel information.

### SUMMARY

An objective of the present disclosure is to provide a method and an apparatus for performing model monitoring during channel state information feedback in a communication system when channel state information is predicted by a terminal using an AI/ML model.

According to a first exemplary embodiment of the present disclosure, a method of a terminal may comprise: receiving, from a base station, a reporting instruction for performance metrics; determining a first performance metric based on first channel state information (CSI) at a first time and second CSI predicted for the first time; determining a second performance metric based on the first CSI and third CSI at a second time; and transmitting, to the base station, the first performance metric and the second performance metric according to the reporting instruction.

The determining of the first performance metric may comprise: receiving, from the base station, a first reference signal (RS) before the first time; determining fourth CSI based on the first RS; predicting the second CSI using an artificial intelligence (AI)/machine learning (ML) model based on the determined fourth CSI; receiving, from the base station, a second RS at the first time; determining the first CSI based on the second RS; and determining the first performance metric based on the first CSI and the second CSI.

The first CSI may comprise first subband CSIs measured for respective subbands, and the second CSI may comprise second subband CSIs predicted for the respective subbands, and the determining of the first performance metric based on the first CSI and the second CSI may comprise: determining first subband performance metrics for the respective subbands based on the first subband CSIs and the second subband CSIs; and determining an average of the first subband performance metrics as the first performance metric.

The first CSI may comprise first layer CSIs measured for respective layers, and the second CSI may comprise second layer CSIs predicted for the respective layers, and the determining of the first performance metric based on the first CSI and the second CSI may comprise: determining first layer performance metrics for the respective layers based on the first layer CSIs and the second layer CSIs; and determining the first layer performance metrics as the first performance metric.

The determining of the second performance metric based on the first CSI and the third CSI at the second time may comprise: receiving, from the base station, a third RS at the second time; determining the third CSI based on the third RS; and determining the second performance metric based on the first CSI and the third CSI.

The third RS may be received in one CSI-RS transmission occasion among CSI-RS transmission occasions earlier than a CSI-RS for CSI prediction reporting.

The transmitting of the first performance metric and the second performance metric to the base station according to the reporting instruction may comprise: determining a first interval index of a first performance metric interval including the first performance metric in a performance metric interval table configured with performance metric intervals and interval indices; determining a second interval index of a second performance metric interval including the second performance metric in the performance metric interval table; and transmitting the first interval index and the second interval index to the base station.

The first performance metric may represent a similarity between a first precoder corresponding to a first precoding matrix indicator (PMI) of the first CSI and a second precoder corresponding to a second PMI of the second CSI, and the second performance metric may represent a similarity between the first precoder and a third precoder corresponding to a third PMI of the third CSI.

According to a second exemplary embodiment of the present disclosure, a method of a base station may comprise: transmitting, to a terminal, a reporting instruction for performance metrics; transmitting, to the terminal, a first reference signal (RS) before a first time; transmitting, to the terminal, a second RS at the first time; transmitting, to the terminal, a third RS at a second time; receiving, from the terminal, a first performance metric and a second performance metric based on the first to third RSs, wherein the first performance metric may be determined based on first channel state information (CSI) of the second RS and second CSI predicted for the first time using an artificial intelligence (AI)/machine learning (ML) model based on the first RS, and the second performance metric may be determined based on the first CSI and third CSI of the third RS.

The first CSI may comprise first subband CSIs measured for respective subbands, and the second CSI may comprise second subband CSIs predicted for the respective subbands, and the first performance metric may be an average of first subband performance metrics for the respective subbands determined based on the first subband CSIs and the second subband CSIs.

The first CSI may comprise first layer CSIs measured for respective layers, and the second CSI may comprise second layer CSIs predicted for the respective layers, and the first performance metric may comprise first layer performance metrics for the respective layers determined based on the first layer CSIs and the second layer CSIs.

The third RS may be transmitted based on one CSI-RS transmission occasion among CSI-RS transmission occasions earlier than a CSI-RS for CSI prediction reporting.

The first performance metric may be indicated by a first interval index of a first performance metric interval including the first performance metric in a performance metric interval table configured with performance metric intervals and interval indices, and the second performance metric may be indicated by a second interval index of a second performance metric interval including the second performance metric in the performance metric interval table.

The first performance metric may represent a similarity between a first precoder corresponding to a first precoding matrix indicator (PMI) of the first CSI and a second precoder corresponding to a second PMI of the second CSI, and the second performance metric may represent a similarity between the first precoder and a third precoder corresponding to a third PMI of the third CSI.

According to a third exemplary embodiment of the present disclosure, a terminal may comprise at least one processor, wherein the at least one processor may cause the terminal to perform: receiving, from a base station, a reporting instruction for performance metrics; determining a first performance metric based on first channel state information (CSI) at a first time and second CSI predicted for the first time; determining a second performance metric based on the first CSI and third CSI at a second time; and transmitting, to the base station, the first performance metric and the second performance metric according to the reporting instruction.

In the determining of the first performance metric, the at least one processor may cause the terminal to perform: receiving, from the base station, a first reference signal (RS) before the first time; determining fourth CSI based on the first RS; predicting the second CSI using an artificial intelligence (AI)/machine learning (ML) model based on the determined fourth CSI; receiving, from the base station, a second RS at the first time; determining the first CSI based on the second RS; and determining the first performance metric based on the first CSI and the second CSI.

The first CSI may comprise first subband CSIs measured for respective subbands, and the second CSI may comprise second subband CSIs predicted for the respective subbands, and in the determining of the first performance metric based on the first CSI and the second CSI, the at least one processor may cause the terminal to perform: determining first subband performance metrics for the respective subbands based on the first subband CSIs and the second subband CSIs; and determining an average of the first subband performance metrics as the first performance metric.

The first CSI may comprise first layer CSIs measured for respective layers, and the second CSI may comprise second layer CSIs predicted for the respective layers, and in the determining of the first performance metric based on the first CSI and the second CSI, the at least one processor may cause the terminal to perform: determining first layer performance metrics for the respective layers based on the first layer CSIs and the second layer CSIs; and determining the first layer performance metrics as the first performance metric.

In the transmitting of the first performance metric and the second performance metric to the base station according to the reporting instruction, the at least one processor may cause the terminal to perform: determining a first interval index of a first performance metric interval including the first performance metric in a performance metric interval table configured with performance metric intervals and interval indices; determining a second interval index of a second performance metric interval including the second performance metric in the performance metric interval table; and transmitting the first interval index and the second interval index to the base station.

The first performance metric may represent a similarity between a first precoder corresponding to a first precoding matrix indicator (PMI) of the first CSI and a second precoder corresponding to a second PMI of the second CSI, and the second performance metric may represent a similarity between the first precoder and a third precoder corresponding to a third PMI of the third CSI.

According to the present disclosure, a base station may receive, from a terminal, a model monitoring result for a UE-sided AI/ML model, and may instruct the terminal to perform operations such as maintaining, modifying, deactivating, or performing legacy fallback of the AI/ML model based on the received model monitoring result. In this manner, the base station can detect a performance state of the UE-sided AI/ML model at an early stage, can ensure continuous performance of the AIML model, and can prevent use of an inaccurate AI/ML model. Accordingly, the base station can reduce a negative impact of channel aging on performance of a communication system.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a conceptual diagram illustrating exemplary embodiments of a radio frame structure used in a communication system.

FIG. 4 is a conceptual diagram illustrating exemplary embodiments of a slot structure for downlink (DL) and uplink (UL) in a communication system.

FIG. 5 is a conceptual diagram illustrating exemplary embodiments of a physical channel and a signal transmission method using the physical channel.

FIG. 6 is a block diagram illustrating exemplary embodiments of a synchronization signal (SS)/physical broadcast channel (PBCH) block structure for initial cell access.

FIGS. 7A and 7B are conceptual diagrams illustrating exemplary embodiments of slots in which an SS/PBCH block is transmitted in each half-frame.

FIG. 8 is a conceptual diagram illustrating exemplary embodiments of control information and a control channel transmission method.

FIG. 9 is a conceptual diagram illustrating exemplary embodiments of aggregation levels of control channel elements (CCEs) and PDCCH multiplexing.

FIG. 10 is a conceptual diagram illustrating exemplary embodiments of a control resource set (CORESET) in which a PDCCH can be transmitted.

FIG. 11 is a conceptual diagram illustrating exemplary embodiments of a method for configuring a PDCCH search space.

FIG. 12 is a conceptual diagram illustrating exemplary embodiments of carrier aggregation.

FIG. 13 is a conceptual diagram illustrating exemplary embodiments of single carrier communication.

FIG. 14 is a conceptual diagram illustrating exemplary embodiments of multi-carrier communication.

FIG. 15 is a conceptual diagram illustrating exemplary embodiments of a cross-carrier scheduling method.

FIG. 16 is a block diagram illustrating exemplary embodiments of a terminal and a base station.

FIG. 17 is a sequence diagram illustrating an exemplary embodiment of a method for reporting a monitoring result of an intelligent model.

FIG. 18 is a sequence diagram illustrating an exemplary embodiment of a method for reporting a monitoring result of an intelligent model.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

In the present disclosure, a phrase including “when ~” may be expressed as a phrase including “based on ~” or a phrase including “in response to ~”. In other words, a phrase including “when ~” may be interpreted as the same as or similar to a phrase including “based on ~” or a phrase including “in response to ~”.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

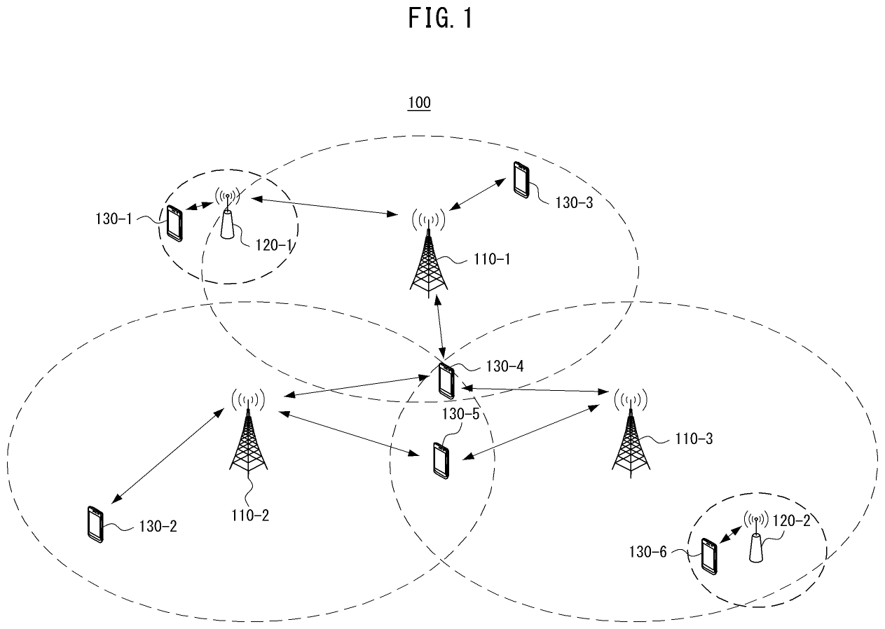

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Here, the communication system may be referred to as a ‘communication network’. Each of the plurality of communication nodes may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, orthogonal frequency division multiple access (OFDMA) based communication protocol, single-carrier FDMA (SC-FDMA) based communication protocol, non-orthogonal multiple access (NOMA) based communication protocol, space division multiple access (SDMA) based communication protocol, or the like. Each of the plurality of communication nodes may have the following structure.

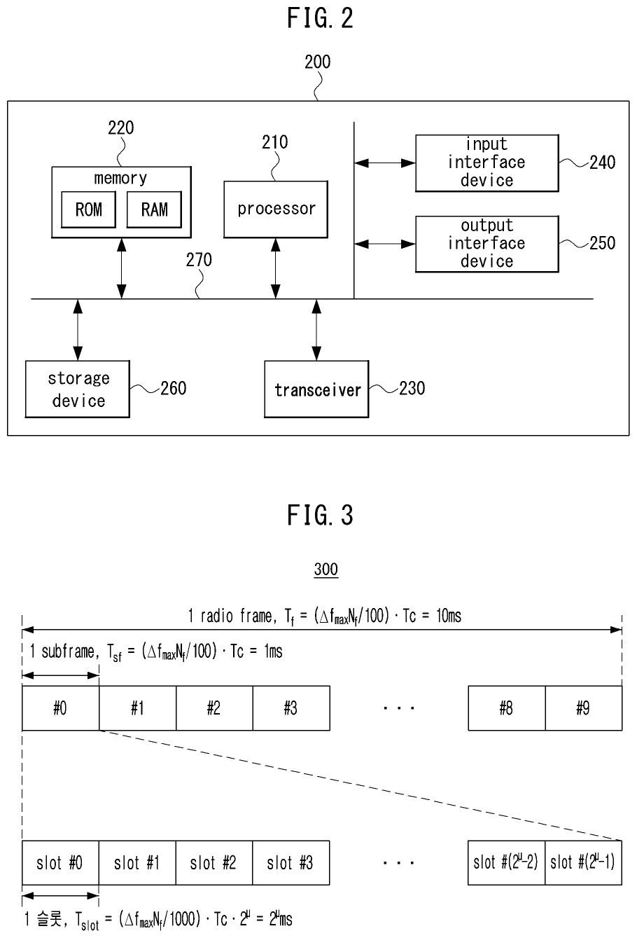

FIG. 2 is a block diagram illustrating exemplary embodiments of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270. However, the respective components included in the communication node 200 may be connected not to the common bus 270 but to the processor 210 through an individual interface or an individual bus. For example, the processor 210 may be connected to at least one of the memory 220, the transceiver 230, the input interface device 240, the output interface device 250, and the storage device 260 through dedicated interfaces.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of user equipments (UEs) 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third UE 130-3, and the fourth UE 130-4 may belong to the cell coverage of the first base station 110-1. Also, the second UE 130-2, the fourth UE 130-4, and the fifth UE 130-5 may belong to the cell coverage of the second base station 110-2. Also, the fifth base station 120-2, the fourth UE 130-4, the fifth UE 130-5, and the sixth UE 130-6 may belong to the cell coverage of the third base station 110-3. Also, the first UE 130-1 may belong to the cell coverage of the fourth base station 120-1, and the sixth UE 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), 5G Node B (gNB), base transceiver station (BTS), radio base station, radio transceiver, access point (AP), access node, road side unit (RSU), digital unit (DU), cloud digital unit (CDU), radio remote head (RRH), radio unit (RU), transmission point (TP), transmission and reception point (TRP), relay node, or the like. Each of the plurality of UE 130-1, 130-2, 130-3, 130-4, 130-5, and 130-6 may be referred to as terminal, access terminal, mobile terminal, station, subscriber station, mobile station, portable subscriber station, node, device, or the like.

Each of the plurality of communication nodes 110-1, 110-2, 110-3, 120-1, 120-2, 130-1, 130-2, 130-3, 130-4, 130-5, and 130-6 may support cellular communication (e.g., LTE, LTE-Advanced (LTE-A), New Radio (NR), etc.). Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding UE 130-1, 130-2, 130-3, 130-4, 130-5, or 130-6 to the core network.

Each of the plurality of base stations 110-1, 110-2, 110-3, 120-1, and 120-2 may support OFDMA-based downlink (DL) transmission, and SC-FDMA-based uplink (UL) transmission. In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), or the like. Here, each of the plurality of UEs 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2).

Meanwhile, after commercialization of the 4th generation (4G) communication system, efforts have been made to develop a new 5th generation (5G) communication system in order to satisfy increasing wireless data traffic demands. The 5G communication system may be referred to as a communication system beyond a 4G network, a post-LTE system, or a new radio (NR) system. In order to achieve a high data transmission rate, the 5G communication system may include a system operated using a millimeter wave (mmWave) band of 6 GHz or higher, and may also include a communication system operated using a frequency band of 6 GHz or lower in terms of securing coverage, and implementation at a base station and a terminal may also be considered.

The 3rd generation partnership project (3GPP) NR system may improve spectrum efficiency of a network so that a communication operator can provide more data and voice services within a given bandwidth. Accordingly, the 3GPP NR system may be designed to satisfy requirements for high-speed data and media transmission as well as support of large-capacity voice. An advantage of the NR system may be that the NR system can provide high throughput, low latency, support for frequency division duplex (FDD) and time division duplex (TDD), an improved end-user experience, and a low operating cost due to a simple architecture on the same platform.

For more efficient data processing, dynamic TDD of the NR system may use a scheme of varying a number of orthogonal frequency division multiplexing (OFDM) symbols usable for uplink and downlink according to a data traffic direction of users of a cell. For example, when downlink traffic of a cell is greater than uplink traffic, a base station may allocate a plurality of downlink OFDM symbols in a slot or a subframe. Information on a slot configuration may be transmitted to terminals.

In order to alleviate path loss of a radio wave in a millimeter wave band and increase a transmission distance of a radio wave, the 5G communication system may use beamforming, massive multiple input multiple output (MIMO), full dimensional MIMO (FD-MIMO), array antennas, analog beam-forming, hybrid beamforming combining analog beamforming and digital beamforming, and large-scale antenna technology.

In addition, in order to improve a network of the system, the 5G communication system has been developed in relation to technologies such as an evolved small cell, an advanced small cell, a cloud radio access network (cloud RAN), an ultra-dense network, device-to-device (D2D) communication, vehicle-to-everything (V2X) communication, a wireless backhaul, non-terrestrial network (NTN) communication, a moving network, cooperative communication, coordinated multi-points (CoMP), and interference cancellation. Further, for the 5G system, advanced coding modulation (ACM) schemes such as hybrid FSK amplitude shift keying modulation (FQAM), quadrature amplitude modulation (QAM) and sliding window superposition coding (SWSC), and advanced access technologies such as filter bank multi-carrier (FBMC), non-orthogonal multiple access (NOMA), and sparse code multiple access (SCMA) are being developed.

Meanwhile, the Internet is evolving from a human-centered connection network in which humans can generate and consume information into an Internet of Things (IoT) network in which distributed components such as objects exchange and process information. An Internet of everything (IoE) technology in which big data processing technology through connection with a cloud server is combined with the IoT technology is also emerging.

In order to implement the IoT, technology elements such as a sensing technology, wired and wireless communication and network infrastructure, a service interface technology, and a security technology are required, and recently, technologies such as a sensor network, machine-to-machine (M2M) communication, and machine-type communication (MTC) for connection between objects are being studied.

In an IoT environment, intelligent Internet technology (IT) services that create new values in human life may be provided by collecting and analyzing data generated from connected objects. The IoT may be applied to fields such as a smart home, a smart building, a smart city, a smart car or a connected car, a smart grid, healthcare, smart home appliances, and advanced medical services through convergence and combination of an existing information technology (IT) and various industries.

Accordingly, various attempts have been made to apply the 5G communication system to an IoT network. For example, technologies such as a sensor network, M2M communication, and MTC may be implemented by techniques such as beamforming, MIMO, and array antennas, which are 5G communication technologies. The cloud RAN, as a big data processing technology, described above may be an example of convergence of the 5G technology and the IoT technology. In general, a mobile communication system has been developed to provide a voice service while ensuring mobility of a user.

However, the mobile communication system is gradually expanding its scope from voice services to data services, and is currently capable of providing high-speed data services. However, due to resource shortages and increasing user demand for high-speed services, a more advanced mobile communication system is required.

Meanwhile, in wireless communication systems, demand for the introduction of AI/ML technologies is increasing for faster, more accurate, and more efficient communication. Accordingly, a wireless communication network may require a specific design for using AI/ML models. An objective of the present disclosure may be to provide AI/ML-based methods for channel state information feedback and apparatuses therefor. More specifically, the present disclosure may provide methods for predicting channel state information using an AI/ML algorithm when performing AI/ML-based channel state information feedback, and apparatuses therefor.

The following technologies may be used in various wireless access systems such as code division multiple access (CDMA), frequency division multiple access (FDMA), time division multiple access (TDMA), orthogonal frequency division multiple access (OFDMA), and single carrier frequency division multiple access (SC-FDMA). CDMA may be implemented using radio technologies such as universal terrestrial radio access (UTRA) or CDMA2000. TDMA may be implemented using radio technologies such as global system for mobile communications (GSM), general packet radio service (GPRS), or enhanced data rates for GSM evolution (EDGE).

OFDMA may be implemented using radio technologies such as IEEE 802.11 (Wi-Fi), IEEE 802.16 (WiMAX), IEEE 802-20, or evolved UTRA (E-UTRA). UTRA may be a part of a universal mobile telecommunications system (UMTS). 3GPP LTE may be a part of an evolved UMTS (E-UMTS) using E-UTRA, and LTE-advanced (LTE-A) may be an evolved version of 3GPP LTE. 3GPP NR may be a system separately designed from LTE/LTE-A to support services of enhanced mobile broadband (eMBB), ultra-reliable and low latency communication (URLLC), and massive machine type communication (mMTC), which are requirements of IMT-2020. For clarity of description, the present disclosure mainly describes 3GPP NR, but the technical scope of the present disclosure may not be limited thereto.

Unless otherwise specified in the present disclosure, a base station may denote a next generation node B (gNB) defined in 3GPP NR. Also, unless otherwise specified, a terminal may denote a user equipment (UE). Hereinafter, for ease of understanding, respective aspects are separately described as exemplary embodiments, but the respective exemplary embodiments may be used in combination. In the present disclosure, configuration of a terminal may be performed by a base station. More specifically, the base station may configure an operation of the terminal or parameters used in a wireless communication system by transmitting a channel or a signal to the terminal.

FIG. 3 is a conceptual diagram illustrating exemplary embodiments of a radio frame structure used in a communication system.

Referring to FIG. 3, a radio frame used in a 3GPP NR system may have a length of 10 ms (=(ΔfₘₐₓN_{f}/100)× T_{c}). The radio frame may include 10 subframes having equal sizes. Δfₘₐₓ, N_{f}, T_{c}, Δf_{ref}, and N_{f,ref} may be defined as Δfₘₐₓ=480×10³ Hz, N_{f}=4096, T_{c}=1/(Δf_{ref}× N_{f,ref}), Δf_{ref}=15×10³ Hz, and N_{f,ref}=2048. Each of the 10 subframes in one radio frame may be assigned a number from 0 to 9.

Each subframe may have a length of 1 ms, and may include one or more slots according to a subcarrier spacing (SCS). More specifically, a subcarrier spacing used in the 3GPP NR system may be 15×2^{μ}kHz. μ may be a subcarrier spacing configuration factor, and may have a value of 0 to 4. That is, 15 kHz, 30 kHz, 60 kHz, 120 kHz, or 240 kHz may be used as the subcarrier spacing. A subframe having a length of 1 ms may include 2 slots.

A length of each slot may be 2^{-μ} ms. 2 slots in one subframe may be assigned numbers from 0 to 2^{μ}-1, respectively. Slots in one radio frame may be assigned numbers from 0 to 10×2^{μ}−1, respectively. A time resource may be identified based on at least one of a radio frame number (or a radio frame index), a subframe number (or a subframe index), or a slot number (or a slot index).

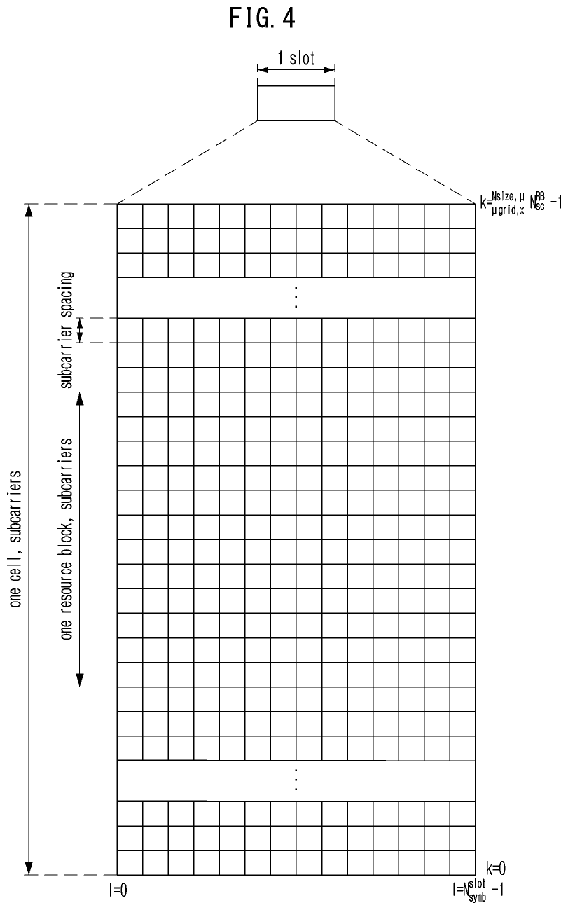

FIG. 4 is a conceptual diagram illustrating exemplary embodiments of a slot structure for downlink (DL) and uplink (UL) in a communication system. In particular, FIG. 4 may represent a resource grid structure of a 3GPP NR system.

There may be one resource grid per antenna port. Referring to FIG. 4, a slot may include a plurality of OFDM symbols in the time domain and may include a plurality of resource blocks (RBs) in the frequency domain. An OFDM symbol may correspond to one symbol duration. Unless otherwise specified, an OFDM symbol may be simply referred to as a symbol. One RB may include 12 consecutive subcarriers in the frequency domain.

Referring to FIG. 4, a signal transmitted in each slot may be represented by a resource grid composed of N^{size,μ}_{grid,x}×N^{RB}_{sc} subcarriers and N^{slot}_{symb} OFDM symbols. Here, when the resource grid is a downlink resource grid, x may be DL, and when the resource grid is an uplink resource grid, x may be UL. N^{size,μ}_{grid,x} may indicate a number of RBs according to a subcarrier spacing configuration factor μ where x is DL or UL, and N^{slot}_{symb} may indicate the number of OFDM symbols in a slot. N^{RB}_{sc} may indicate the number of subcarriers constituting one RB, and may be defined as 12. An OFDM symbol may be referred to as a cyclic prefix OFDM (CP-OFDM) symbol or a discrete Fourier transform spread OFDM (DFT-S-OFDM) symbol according to a multiple access scheme.

The number of OFDM symbols included in one slot may vary according to a length of a cyclic prefix (CP). For example, in the case of a normal CP, one slot may include 14 OFDM symbols. In the case of an extended CP, one slot may include 12 OFDM symbols. In a specific exemplary embodiment, the extended CP may be used only at a subcarrier spacing of 60 kHz.

For convenience of description, a case in which one slot is composed of 14 OFDM symbols is illustrated in FIG. 4, but exemplary embodiments of the present disclosure may be similarly applied to a slot having a different number of OFDM symbols. Referring to FIG. 4, each OFDM symbol may include N^{size,μ}_{grid,x}×N^{RB}_{sc} subcarriers in the frequency domain. A type of a subcarrier may be classified into a data subcarrier for data transmission, a reference signal subcarrier for transmission of a reference signal, and a guard band. A carrier frequency may also be defined by a center frequency fc.

One RB may be defined by N^{RB}_{sc} consecutive subcarriers (e.g. 12 subcarriers) in the frequency domain. A resource composed of one OFDM symbol and one subcarrier may be referred to as a resource element (RE) or a tone. Accordingly, one RB may include N^{slot}_{symb}×N^{RB}_{sc} REs. Each RE in a resource grid may be uniquely defined by an index pair (k, 1) within one slot. k may be an index assigned from 0 to N^{size,μ}_{grid,x}λN^{RB}_{sc}−1 in the frequency domain, and 1 may be an index assigned from 0 to N^{slot}_{symb}−1 in the time domain.

A terminal may receive a signal from a base station. Alternatively, the terminal may transmit a signal to the base station. In order to perform such an operation, the terminal may need to align time and frequency synchronization of the terminal with time/frequency synchronization of the base station. Only when the base station and the terminal are synchronized, the terminal may determine time and frequency parameters required for accurately performing demodulation of a DL signal and transmission of a UL signal at a correct time.

Each symbol of a radio frame operating in TDD or an unpaired spectrum may be configured as at least one of a DL symbol, a UL symbol, or a flexible symbol. A radio frame associated with a DL carrier in FDD or a paired spectrum may be composed of DL symbols or flexible symbols, and a radio frame associated with a UL carrier may be composed of UL symbols or flexible symbols.

In a DL symbol, DL transmission may be possible, but UL transmission may not be possible. In a UL symbol, UL transmission may be possible, but DL transmission may not be possible. A flexible symbol may be used as a DL symbol or as a UL symbol according to a signal.

Information on the type of each symbol, that is, information indicating one of a DL symbol, a UL symbol, and a flexible symbol, may be configured by cell-specific or common radio resource control (RRC) signaling. Information on a type of each symbol may be additionally configured by UE-specific or dedicated RRC signaling. The base station may indicate, using cell-specific RRC signaling, i) a periodicity of a cell-specific slot configuration, ii) a number of slots having only DL symbols from the beginning of a period of the cell-specific slot configuration, iii) a number of DL symbols from a first symbol of a slot immediately following a slot having only DL symbols, iv) a number of slots having only UL symbols from the end of a period of the cell-specific slot configuration, and v) a number of UL symbols from a last symbol of a slot immediately preceding a slot having only UL symbols.

A symbol that is neither a UL symbol nor a DL symbol may be a flexible symbol. When information on a symbol type is configured by UE-specific RRC signaling, the base station may signal whether a flexible symbol is a DL symbol or a UL symbol through cell-specific RRC signaling. UE-specific RRC signaling may not change a DL symbol or a UL symbol configured by cell-specific RRC signaling to another symbol type. The UE-specific RRC signaling may signal, for each slot, a number of DL symbols among N^{slot}_{symb} symbols of a slot and a number of UL symbols among N^{slot}_{symb} symbols of the slot.

DL symbols of a slot may be consecutively arranged from a first symbol of a slot to an i-th symbol. UL symbols of a slot may be consecutively composed from a j-th symbol to a last symbol. Here, i and j may be defined as i<j. A symbol that is neither a UL symbol nor a DL symbol in a slot may be a flexible symbol.

The type of a symbol configured by the above-described RRC signaling may be referred to as a semi-static DL/UL configuration. In the semi-static DL/UL configuration configured by RRC signaling, a flexible symbol may be indicated as a DL symbol, a UL symbol, or a flexible symbol through dynamic slot format information (SFI) transmitted on a physical downlink control channel (PDCCH). In this case, a DL symbol or a UL symbol configured by the RRC signaling may not be changed to another symbol type. Tables 1 and 2 may illustrate dynamic SFI indicated by the base station to the terminal.

TABLE 1

| | Symbol number in a slot | | | | | | | | | | | | | |
|---|---|---|---|---|---|---|---|---|---|---|---|---|---|---|
| Index | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 4 | D | D | D | D | D | D | D | D | D | D | D | D | F | F |
| 5 | D | D | D | D | D | D | D | D | D | D | D | F | F | F |
| 6 | D | D | D | D | D | D | D | D | D | D | F | F | F | F |
| 7 | D | D | D | D | D | D | D | D | D | F | F | F | F | F |
| 8 | F | F | F | F | F | F | F | F | F | F | F | F | F | U |
| 9 | F | F | F | F | F | F | F | F | F | F | F | F | U | U |
| 10 | F | U | U | U | U | U | U | U | U | U | U | U | U | U |
| 11 | F | F | U | U | U | U | U | U | U | U | U | U | U | U |
| 12 | F | F | F | U | U | U | U | U | U | U | U | U | U | U |
| 13 | F | F | F | F | U | U | U | U | U | U | U | U | U | U |
| 14 | F | F | F | F | F | U | U | U | U | U | U | U | U | U |
| 15 | F | F | F | F | F | F | U | U | U | U | U | U | U | U |
| 16 | D | F | F | F | F | F | F | F | F | F | F | F | F | F |
| 17 | D | D | F | F | F | F | F | F | F | F | F | F | F | F |
| 18 | D | D | D | F | F | F | F | F | F | F | F | F | F | F |
| 19 | D | F | F | F | F | F | F | F | F | F | F | F | F | U |
| 20 | D | D | F | F | F | F | F | F | F | F | F | F | F | U |
| 21 | D | D | D | F | F | F | F | F | F | F | F | F | F | U |
| 22 | D | F | F | F | F | F | F | F | F | F | F | F | U | U |
| 23 | D | D | F | F | F | F | F | F | F | F | F | F | U | U |
| 24 | D | D | D | F | F | F | F | F | F | F | F | F | U | U |
| 25 | D | F | F | F | F | F | F | F | F | F | F | U | U | U |
| 26 | D | D | F | F | F | F | F | F | F | F | F | U | U | U |
| 27 | D | D | D | F | F | F | F | F | F | F | F | U | U | U |
| 28 | D | D | D | D | D | D | D | D | D | D | D | D | F | U |
| 29 | D | D | D | D | D | D | D | D | D | D | D | F | F | U |

TABLE 2

| | Symbol number in a slot | | | | | | | | | | | | | |
|---|---|---|---|---|---|---|---|---|---|---|---|---|---|---|
| Index | 0 | 1 | 2 | 3 | 4 | 5 | 6 | 7 | 8 | 9 | 10 | 11 | 12 | 13 |
| 30 | D | D | D | D | D | D | D | D | D | D | F | F | F | U |
| 31 | D | D | D | D | D | D | D | D | D | D | D | F | U | U |
| 32 | D | D | D | D | D | D | D | D | D | D | F | F | U | U |
| 33 | D | D | D | D | D | D | D | D | D | F | F | F | U | U |
| 34 | D | F | U | U | U | U | U | U | U | U | U | U | U | U |
| 35 | D | D | F | U | U | U | U | U | U | U | U | U | U | U |
| 36 | D | D | D | F | U | U | U | U | U | U | U | U | U | U |
| 37 | D | F | F | U | U | U | U | U | U | U | U | U | U | U |
| 38 | D | D | F | F | U | U | U | U | U | U | U | U | U | U |
| 39 | D | D | D | F | F | U | U | U | U | U | U | U | U | U |
| 40 | D | F | F | F | U | U | U | U | U | U | U | U | U | U |
| 41 | D | D | F | F | F | U | U | U | U | U | U | U | U | U |
| 42 | D | D | D | F | F | F | U | U | U | U | U | U | U | U |
| 43 | D | D | D | D | D | D | D | D | D | F | F | F | F | U |
| 44 | D | D | D | D | D | D | F | F | F | F | F | F | U | U |
| 45 | D | D | D | D | D | D | F | F | U | U | U | U | U | U |
| 46 | D | D | D | D | D | F | U | D | D | D | D | D | F | U |
| 47 | D | D | F | U | U | U | U | D | D | F | U | U | U | U |
| 48 | D | F | U | U | U | U | U | D | F | U | U | U | U | U |
| 49 | D | D | D | D | F | F | U | D | D | D | D | F | F | U |
| 50 | D | D | F | F | U | U | U | D | D | F | F | U | U | U |
| 51 | D | F | F | U | U | U | U | D | F | F | U | U | U | U |
| 52 | D | F | F | F | F | F | U | D | F | F | F | F | F | U |
| 53 | D | D | F | F | F | F | U | D | D | F | F | F | F | U |
| 54 | F | F | F | F | F | F | F | D | D | D | D | D | D | D |
| 55 | D | D | F | F | F | U | U | U | D | D | D | D | D | D |

| | |
|---|---|
| 56-255 | Reserved |

In Tables 1 and 2, D may indicate DL symbols, U may indicate UL symbols, and F may indicate flexible symbols. As in Tables 1 and 2, up to two DL/UL switching within one slot may be allowed.

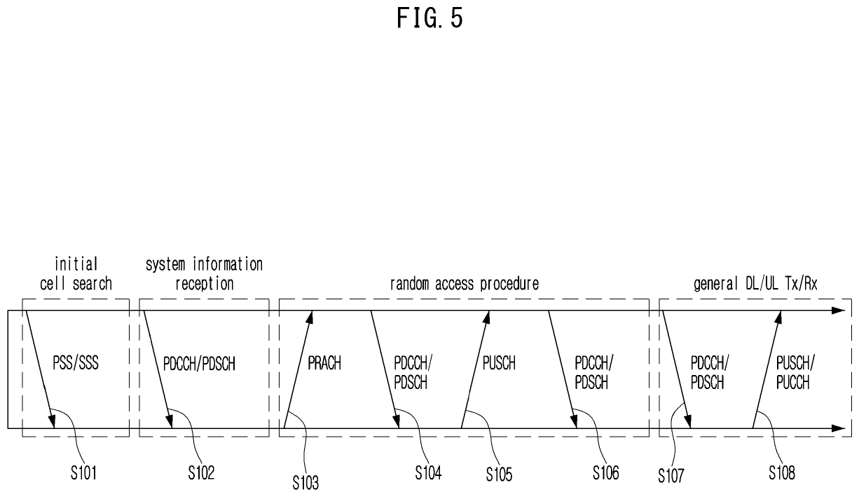

FIG. 5 is a conceptual diagram illustrating exemplary embodiments of a physical channel and a signal transmission method using the physical channel.

Referring to FIG. 5, when a terminal is powered on or when a terminal newly enters a cell, the terminal may perform an initial cell search procedure (S101). More specifically, the terminal may acquire synchronization with a base station in the initial cell search procedure. For this purpose, the terminal may receive a primary synchronization signal (PSS) and a secondary synchronization signal (SSS) from the base station to acquire synchronization with the base station, and may acquire information such as a cell identifier (ID). Thereafter, the terminal may receive a physical broadcast channel from the base station and may acquire broadcast information within a cell.

After completing the initial cell search procedure, the terminal may acquire more specific system information than system information obtained through the initial cell search procedure by receiving a PDCCH and a physical downlink shared channel (PDSCH) according to information carried on the PDCCH (S102). Here, the system information received by the terminal may be cell-common system information for correct operation of the terminal in a physical layer, and may be referred to as remaining system information or system information block (SIB1).

The terminal may not have radio resources for initial access or signal transmission to the base station. In such a case, the terminal may be in an RRC idle mode (e.g. RRC_IDLE state). In such a case, the terminal may perform a random access procedure with respect to the base station (S103 to S106).

First, the terminal may transmit a preamble through a physical random access channel (PRACH) (S103). The base station may receive the preamble from the terminal. The base station may transmit a response message for the preamble to the terminal. Accordingly, the terminal may receive the response message for the preamble through a PDCCH and a corresponding PDSCH from the base station (S104). The terminal may receive a valid random access response message.

In this case, the terminal may transmit data including an identifier of the terminal to the base station through a physical uplink shared channel (PUSCH) indicated by an uplink grant transmitted through the PDCCH from the base station (S105). The base station may receive the data including the identifier from the terminal. The base station may transmit a PDCCH for contention resolution to the terminal.

The terminal may wait for the PDCCH as an instruction of the base station for contention resolution. The terminal may successfully receive the PDCCH based on the identifier of the terminal (S106). In this case, the random access procedure may be completed. The terminal may acquire terminal-specific system information required for correct operation of the terminal in an RRC layer and a physical layer during the random access procedure. When the terminal acquires the terminal-specific system information from the RRC layer, the terminal may enter an RRC connected mode (e.g. RRC_CONNECTED state).

The RRC layer may be used for generation and management of control messages between the terminal and a radio access network (RAN). More specifically, the base station and the terminal may perform broadcast of cell system information required for all terminals within the cell, delivery of paging messages, mobility management and handover, measurement reporting by the terminal and control thereof, and capability management and storage management of the terminal in the RRC layer. In general, updating of a signal transmitted in the RRC layer (hereinafter, an RRC signal) may be have a longer update periodicity than a transmission time interval (TTI) in the physical layer, and thus the RRC signal may be maintained without change for a long period.

After the above-described procedure, the terminal may perform reception of PDCCH/PDSCH (S107) and transmission of a physical uplink shared channel (PUCCH) or a physical uplink control channel (PUCCH) (S108) as part of a general uplink/downlink signal transmission procedure. In particular, the terminal may receive downlink control information (DCI) through a PDCCH.

The DCI may include control information such as resource allocation information for the terminal. The DCI may have different formats depending on the purpose. Uplink control information (UCI) transmitted by the terminal to the base station through the uplink may include a downlink/uplink acknowledgement (ACK)/negative acknowledgement (NACK) signal, a channel quality indicator (CQI), a precoding matrix index (PMI), and a rank indicator (RI). CQI, PMI, and RI may be included in channel state information (CSI). In the 3GPP NR system, the terminal may transmit control information such as the above-described hybrid automatic repeat and request (HARQ) ACK and CSI through a PUSCH and/or a PUCCH.

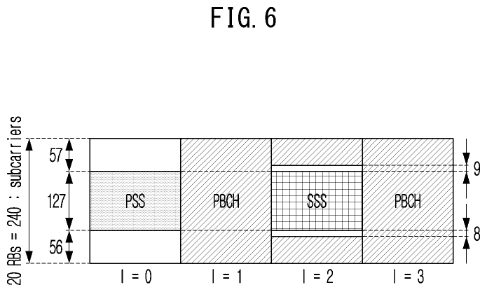

FIG. 6 is a block diagram illustrating exemplary embodiments of a synchronization signal (SS)/physical broadcast channel (PBCH) block structure for initial cell access.

Referring to FIG. 6, when a terminal is powered on or when a terminal attempts to access a cell, the terminal may acquire time and frequency synchronization with the cell and may perform an initial cell search procedure. The terminal may detect a physical cell identity N^{cell}_{ID} of the cell in the cell search procedure. For this purpose, the terminal may receive a synchronization signal (e.g. PSS and SSS) from a base station to acquire synchronization with the base station. In this case, the terminal may acquire information such as a cell ID.

The synchronization signal (SS) may be divided into a PSS and an SSS. The PSS may be used to obtain time-domain synchronization such as OFDM symbol synchronization and slot synchronization and/or frequency-domain synchronization. The SSS may be used to acquire frame synchronization and a cell group ID. Table 3 may provide a detailed description of the synchronization signal.

Referring to FIG. 6 and Table 3, an SS/PBCH block may be composed of 20 RBs (i.e. 240 subcarriers) that are contiguous in the frequency domain, and may be composed of 4 OFDM symbols contiguous in the time domain. In the SS/PBCH block, the PSS may be transmitted through subcarriers 56 to 182 in the first OFDM symbol, and the SSS may be transmitted through subcarriers 56 to 182 in the third OFDM symbol. The lowest subcarrier index of the SS/PBCH block may be is set to 0. In the first OFDM symbol in which the PSS is transmitted, the base station may not transmit a signal through remaining subcarriers, namely, subcarriers 0 to 55 and subcarriers 183 to 239. In the third OFDM symbol in which the SSS is transmitted, the base station may not transmit a signal through subcarriers 48 to 55 and subcarriers 183 to 191. The base station may transmit a PBCH through remaining REs excluding the above signals in the SS/PBCH block.

TABLE 3

| | OFDM | |
|---|---|---|
| Channel | symbol | |
| or signal | number 1 | Subcarrier number k |
| PSS | 0 | 56~182 |
| SSS | 2 | 56~182 |
| Set to 0 | 0 | 0~55, 183~239 |
| | 2 | 48~55, 183~191 |
| PBCH | 1, 3 | 0~239 |
| | 2 | 0~47, 192~239 |
| Demodulation | 1, 3 | 0 + ν, 4 + ν, 8 + ν, . . . , 236 + ν |
| reference | 2 | 0 + ν, 4 + ν, 8 + ν, . . . , 44 + ν |
| signal (DMRS) | | 192 + ν, 196 + ν, . . . , 236 + ν |
| for PBCH | | |

The SS may be used to generated a total of 1008 unique physical-layer cell IDs based on a combination of three PSSs and SSSs. More specifically, the physical-layer cell IDs may be grouped into 336 physical-layer cell-identifier groups such that each group includes three unique identifiers and each physical-layer cell ID belongs to a single physical-layer cell-identifier group. Accordingly, a physical layer cell ID N^{cell}_{ID}=3N⁽¹⁾_{ID}+N⁽²⁾_{ID} may be uniquely defined by an index N⁽¹⁾_{ID} within a range of 0 to 335 indicating a physical-layer cell-identifier group, and an index N⁽²⁾_{ID} within a range of 0 to 2 indicating a physical-layer identifier within the physical-layer cell-identifier group.

The terminal may detect the PSS and may identify one of three unique physical-layer identifiers. The terminal may also detect the SSS and may identify one of 336 physical-layer cell IDs associated with the physical-layer identifier. A sequence d_{PSS}(n) of the PSS may be expressed by Equations 1 to 3.

$$\begin{matrix}{d}_{PSS} ( n ) = 1 - 2 x ( m ) \\ m = ( n + 43 {N}_{ID}^{( 2 )} ) mod 127 \\ 0 \leq n < 127\end{matrix} \qquad [ Equation 1 ]$$

$$x ( i + 7 ) = ( x ( i + 4 ) + x ( i ) ) mod 2 \qquad [ Equation 2 ]$$

$$[ \begin{matrix}x ( 6 ) & x ( 5 ) & x ( 4 ) & x ( 3 ) & x ( 2 ) & x ( 1 ) & x ( 0 )\end{matrix} ] = [ \begin{matrix}1 & 1 & 1 & 0 & 1 & 1 & 0\end{matrix} ] \qquad [ Equation 3 ]$$

The sequence dₛₛₛ(n) of the SSS may be expressed by Equations 4 to 6.

$$\begin{matrix}{d}_{SSS} ( n ) = [ 1 - 2 {x}_{0} ( ( n + {m}_{0} ) mod 127 ) ] [ 1 - 2 {x}_{1} ( ( n + {m}_{1} ) mod 127 ) ] \\ {m}_{0} = 15 ⌊ \frac{{N}_{ID}^{( 1 )}}{112} ⌋ + 5 {N}_{ID}^{( 2 )} \\ {m}_{1} = {N}_{ID}^{( 1 )} mod 112 \\ 0 \leq n < 127\end{matrix} \qquad [ Equation 4 ]$$

$$\begin{matrix}{x}_{0} ( i + 7 ) = ( {x}_{0} ( i + 4 ) + {x}_{0} ( i ) ) mod 2 \\ {x}_{1} ( i + 7 ) = ( {x}_{1} ( i + 1 ) + {x}_{1} ( i ) ) mod 2\end{matrix} \qquad [ Equation 5 ]$$

$$\begin{matrix}[ \begin{matrix}{x}_{0} ( 6 ) & {x}_{0} ( 5 ) & {x}_{0} ( 4 ) & {x}_{0} ( 3 ) & {x}_{0} ( 2 ) & {x}_{0} ( 1 ) & {x}_{0} ( 0 )\end{matrix} ] = [ \begin{matrix}0 & 0 & 0 & 0 & 0 & 0 & 1\end{matrix} ] \\ [ \begin{matrix}{x}_{1} ( 6 ) & {x}_{1} ( 5 ) & {x}_{1} ( 4 ) & {x}_{1} ( 3 ) & {x}_{1} ( 2 ) & {x}_{1} ( 1 ) & {x}_{1} ( 0 )\end{matrix} ] = [ \begin{matrix}0 & 0 & 0 & 0 & 0 & 0 & 1\end{matrix} ]\end{matrix} \qquad [ Equation 6 ]$$

A radio frame having a length of 10 ms may be divided into two half-frames each having a length of 5 ms.

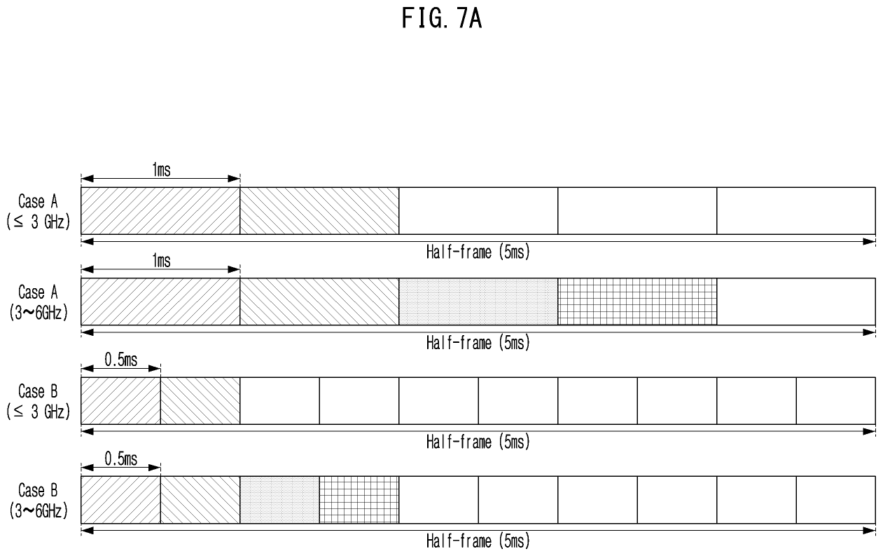

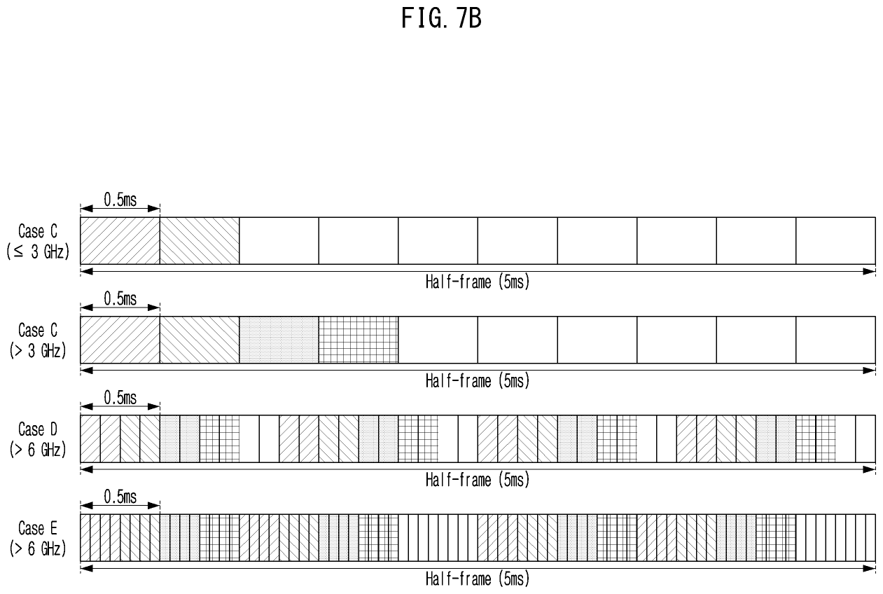

FIGS. 7A and 7B are conceptual diagrams illustrating exemplary embodiments of slots in which an SS/PBCH block is transmitted in each half-frame.

Referring to FIGS. 7A and 7B, slots in which an SS/PBCH block is transmitted may correspond to one of Case A, Case B, Case C, Case D, and Case E. In Case A, a subcarrier spacing may be 15 kHz, and a start time of the SS/PBCH block may correspond to a ({2,8}+14×n)-th symbol. For carrier frequencies of 3 GHz or less, n may be 0 or 1. For carrier frequencies greater than 3 GHz and less than or equal to 6 GHz, n may be 0, 1, 2, or 3. In Case B, a subcarrier spacing may be 30 kHz, and a start time of the SS/PBCH block may correspond to a ({4, 8, 16, 20}+28×n)-th symbol.

For carrier frequencies of 3 GHz or less, n may be 0. For carrier frequencies greater than 3 GHz and less than or equal to 6 GHz, n may be 0 or 1. In Case C, a subcarrier spacing may be 30 kHz, and a start time of the SS/PBCH block may correspond to a ({2, 8}+14×n)-th symbol. For carrier frequencies of 3 GHz or less, n may be 0 or 1. For carrier frequencies greater than 3 GHz and less than or equal to 6 GHz, n may be 0, 1, 2, or 3.

In Case D, a subcarrier spacing may be 120 kHz, and a start time of the SS/PBCH block may correspond to a ({4, 8, 16, 20}+28×n)-th symbol. For carrier frequencies of 6 GHz or more, n may be 0, 1, 2, 3, 5, 6, 7, 8, 10, 11, 12, 13, 15, 16, 17, or 18. In Case E, a subcarrier spacing may be 240 kHz, and a start time of the SS/PBCH block may correspond to a ({8, 12, 16, 20, 32, 36, 40, 44}+56×n)-th symbol. For carrier frequencies of 6 GHz or more, n may be 0, 1, 2, 3, 5, 6, 7, or 8.

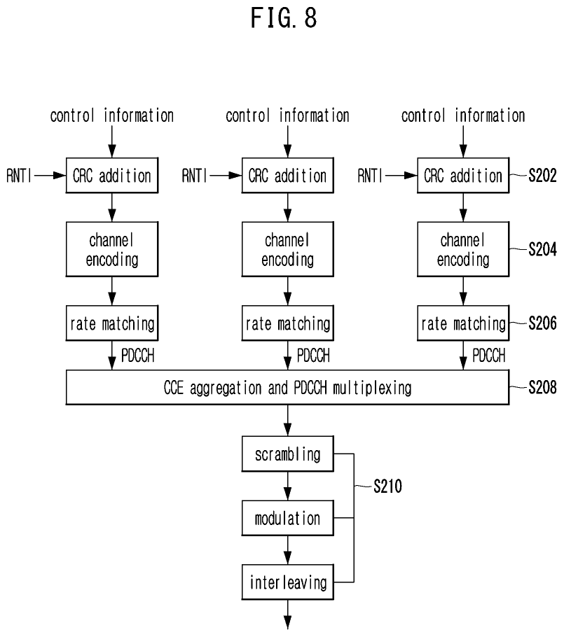

FIG. 8 is a conceptual diagram illustrating exemplary embodiments of control information and a control channel transmission method.

Referring to FIG. 8, a base station may add a cyclic redundancy check (CRC) masked with a radio network temporary identifier (RNTI) (e.g. by an XOR operation) to control information (e.g. DCI) (S202). The base station may scramble the CRC with an RNTI value determined depending on the purpose or target of the control information. A common RNTI used by one or more terminals may include at least one of a system information RNTI (SI-RNTI), a paging RNTI (P-RNTI), a random access RNTI (RA-RNTI), and a transmit power control RNTI (TPC-RNTI). A terminal-specific RNTI may include at least one of a cell temporary RNTI (C-RNTI) and a configured scheduling RNTI (CS-RNTI).

The base station may perform channel encoding (e.g. polar coding) (5204), and may perform rate-matching according to an amount of resources used for PDCCH transmission (5206). The base station may multiplex DCI(s) based on a control channel element (CCE)-based PDCCH structure (5208). The base station may apply additional processes such as scrambling and modulation (e.g. quadrature phase shift keying (QPSK) modulation) and interleaving to the multiplexed DCI(s) (S210) and may map the multiplexed DCI(s) to transmission resources.

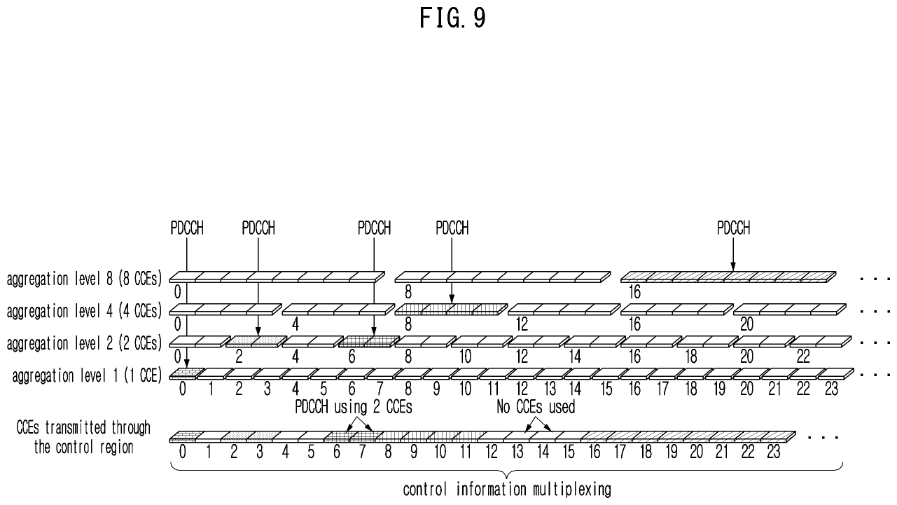

FIG. 9 is a conceptual diagram illustrating exemplary embodiments of aggregation levels of control channel elements (CCEs) and PDCCH multiplexing.

Referring to FIG. 9, a CCE may be a basic resource unit of a PDCCH. One CCE may include a plurality of resource element groups (REGs) (e.g. 6 REGs). One REG may include a plurality of REs (e.g. 12 REs). The number of CCEs used for one PDCCH may be defined as an aggregation level. In the 3GPP NR system, aggregation levels of 1, 2, 4, 8, or 16 may be used.

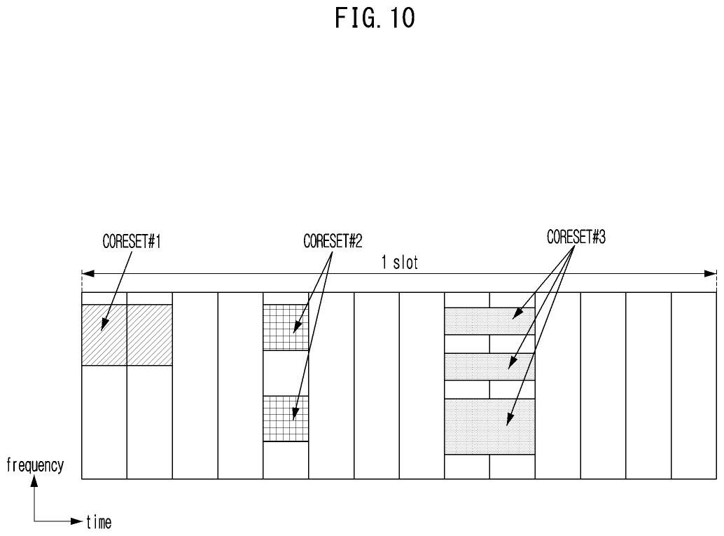

FIG. 10 is a conceptual diagram illustrating exemplary embodiments of a control resource set (CORESET) in which a PDCCH can be transmitted.

Referring to FIG. 10, a CORESET may be a time-frequency resource in which a PDCCH, which is a control channel for a terminal, is transmitted. A search space described below may be mapped to one CORESET. Accordingly, the terminal may decode a PDCCH mapped to the CORESET by monitoring a time-frequency region designated as the CORESET rather than monitoring an entire frequency band.

A base station may configure one or more CORESETs for a terminal in each cell. The CORESET may include up to three consecutive symbols in the time domain. The CORESET may be composed of units of six consecutive physical resource blocks (PRBs) in the frequency domain. In the exemplary embodiment of FIG. 10, CORESET #1 is composed of consecutive PRBs, and CORESET #2 and CORESET #3 are composed of non-consecutive PRBs. The CORESET may be located at any symbol within a slot. For example, in the exemplary embodiment of FIG. 10, CORESET #1 may start from a first symbol of a slot, CORESET #2 may start from a fifth symbol of the slot, and CORESET #3 may start from a ninth symbol of the slot.

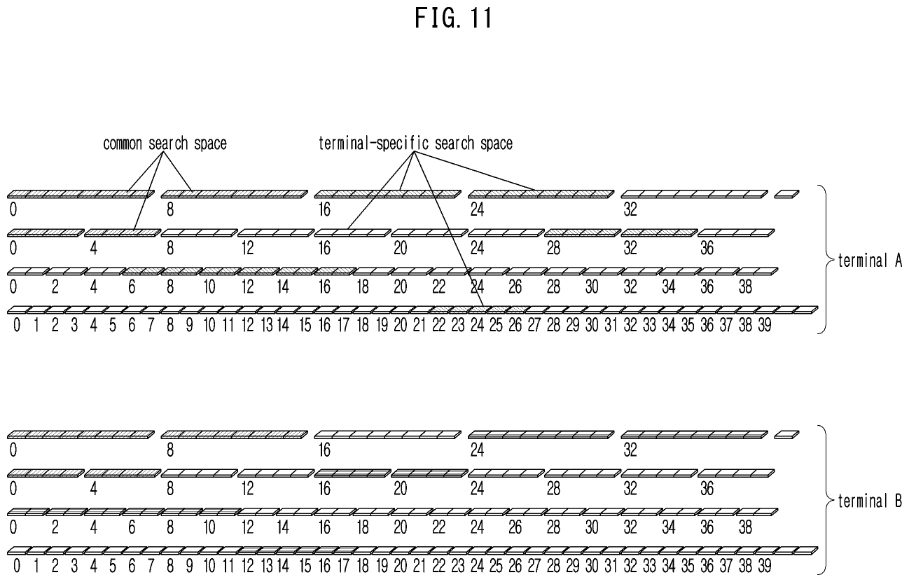

FIG. 11 is a conceptual diagram illustrating exemplary embodiments of a method for configuring a PDCCH search space.

Referring to FIG. 11, to transmit a PDCCH to a terminal, each CORESET may have at least one search space. In an exemplary embodiment of the present disclosure, a search space may be a set of time-frequency resources (hereinafter PDCCH candidates) capable of transmitting a PDCCH for the terminal. The search space may include a common search space that is monitored by all terminals in 3GPP NR and a terminal-specific search space that is monitored by a specific terminal.

In the common search space, all terminals in a cell belonging to the same base station may monitor a PDCCH configured for common monitoring. The terminal-specific search space may be configured for each terminal so that each terminal can monitor a PDCCH allocated to each terminal at a different search space position. In the case of the terminal-specific search space, due to a limited control region in which a PDCCH may be allocated, search spaces among terminals may partially overlap.

Monitoring a PDCCH may include blind decoding of PDCCH candidates within a search space. A case in which blind decoding succeeds may be expressed as a case in which a PDCCH is successfully detected or received, and a case in which blind decoding fails may be expressed as a case in which a PDCCH is not detected or received, or is not successfully detected or received.

For convenience of description, a PDCCH scrambled with a group common RNTI (GC-RNTI) known to one or more terminals in order to transmit downlink control information to one or more terminals may be referred to as a GC-PDCCH or a common PDCCH. In addition, a PDCCH scrambled with a terminal-specific RNTI known to a specific terminal in order to transmit uplink scheduling information or downlink scheduling information to a specific terminal may be referred to as a terminal-specific PDCCH. The common PDCCH may be included in the common search space, and the terminal-specific PDCCH may be included in the common search space or the terminal-specific search space.

The base station may inform each terminal or a terminal group of resource allocation information for a paging channel (PCH) and a downlink-shared channel (DL-SCH) (i.e. a DL grant), or resource allocation information for an uplink-shared channel (UL-SCH) and HARQ (i.e. a UL grant), through a PDCCH. The base station may transmit a PCH transport block and a DL-SCH transport block through a PDSCH. The base station may transmit data excluding specific control information or specific service data through a PDSCH. The terminal may receive the data excluding specific control information or specific service data through the PDSCH.

The base station may include, in a PDCCH, information indicating to which terminal (one or more terminals) data of a PDSCH is transmitted, how the terminal receives the PDSCH data, and how the terminal should decode the PDSCH data. For example, it may be assumed that DCI transmitted through a specific PDCCH is CRC-masked with an RNTI ‘A’, that the DCI indicates that a PDSCH is allocated to a radio resource ‘B’ (e.g. a frequency position), and that the DCI indicates transmission format information ‘C’ (e.g. a transport block size, a modulation scheme, and coding information). The terminal may monitor a PDCCH using the terminal's RNTI. In this case, the terminal may perform PDCCH blind decoding using the RNTI ‘A’. In this case, the terminal may receive a PDCCH and may receive a PDSCH indicated by ‘B’ and ‘C’ based on the received PDCCH. Table 4 may illustrate exemplary embodiments of a PUCCH used in a wireless communication system.

TABLE 4

| | OFDM | |
|---|---|---|
| PUCCH | symbol | Number |
| format | length | of bits |
| 0 | 1-2 | ≤2 |
| 1 | 4-14 | ≤2 |
| 2 | 1-2 | >2 |
| 3 | 4-14 | >2 |
| 4 | 4-14 | >2 |

A PUCCH may be used to transmit the following UCI.
Scheduling request (SR): The SR may be information used to request an uplink UL-SCH resource.
HARQ-ACK: The HARQ-ACK may be a response to a PDCCH indicating DL semi-persistent scheduling (SPS) release and/or a response to a downlink transport block (TB) on a PDSCH. The HARQ-ACK may indicate whether reception of information transmitted through a PDCCH or a PDSCH is successful. AHARQ-ACK response may include a positive ACK, a negative ACK (NACK), a discontinuous transmission (DTX), or NACK/DTX. Here, the term ‘HARQ-ACK’ may be interchangeably used with HARQ-ACK/NACK and ACK/NACK. In general, the ACK may be represented by a bit value of 1, and the NACK may be represented by a bit value of 0.
Channel state information (CSI): The CSI may be feedback information for a downlink channel. The terminal may receive a CSI-reference signal (CSI-RS) from the base station and may generate CSI based on the received CSI-RS. MIMO-related feedback information may include an RI and a PMI. The CSI may be divided into CSI part 1 and CSI part 2 according to information represented by the CSI.

Five PUCCH formats may be used in the 3GPP NR system in order to support various service scenarios, various channel environments, and various frame structures. A PUCCH format 0 may be a format capable of transmitting 1-bit or 2-bit HARQ-ACK information or SR. The PUCCH format 0 may be transmitted over 1 or 2 OFDM symbols in the time domain and over 1 PRB in the frequency domain. When the PUCCH format 0 is transmitted with 2 OFDM symbols, the same sequence may be transmitted on different RBs over the 2 symbols. In this case, the sequence may be a sequence obtained by cyclically shifting a base sequence used for the PUCCH format 0. Through this, the terminal may obtain a frequency diversity gain.

More specifically, the terminal may determine a cyclic shift (CS) value m_{cs} based on UCI of M_{bit} bits (i.e. M_{bit} is 1 or 2). In addition, the terminal may map a sequence obtained by cyclically shifting a base sequence having a length of 12 based on a predetermined CS value mₑₛ to 12 REs of one OFDM symbol and one RB and transmit the sequence. When the number of cyclic shifts usable by the terminal is 12 and M_{bit} is 1, 1-bit UCI 0 and 1 may be respectively mapped to two cyclically shifted sequences having a cyclic shift difference of 6. In addition, when M_{bit} is 2, 2-bit UCIs 00, 01, 11, or 10 may be mapped to four cyclically shifted sequences having a cyclic shift difference of 3.

A PUCCH format 1 may be capable of transmitting 1-bit or 2-bit HARQ-ACK information or SR. The PUCCH format 1 may be transmitted through consecutive OFDM symbols in the time domain and through one PRB in the frequency domain. Here, the number of OFDM symbols occupied by the PUCCH format 1 may be one of 4 to 14. More specifically, UCI when M_{bit}=1 may be modulated with binary phase shift keying (BPSK). The terminal may modulate UCI when M_{bit}=2 with quadrature phase shift keying (QPSK).

A signal may be obtained by multiplying a modulated complex valued symbol d(0) by a sequence having a length of 12. The sequence may be a base sequence used for the PUCCH format 0. The terminal may spread the obtained signal using a time-domain orthogonal cover code (OCC) in even-numbered OFDM symbols allocated to the PUCCH format 1 and may transmit the signal. The PUCCH format 1 may determine a maximum number of terminals multiplexed on the same RBs according to a length of the OCC used. DMRS may be spread using an OCC and may be mapped to odd-numbered OFDM symbols of the PUCCH format 1.

A PUCCH format 2 may be capable of transmitting UCI exceeding 2 bits. The PUCCH format 2 may be transmitted over 1 or 2 OFDM symbols in the time domain and over one or more RBs in the frequency domain. When the PUCCH format 2 is transmitted with 2 OFDM symbols, the same sequence may be transmitted on different RBs over the 2 OFDM symbols. Here, the sequence may include a plurality of modulated complex symbols d(0), . . . , d(M_{symbol}−1). Here, M_{symbol} may be M_{bit}/2. Through this, the terminal may obtain a frequency diversity gain. More specifically, UCI when M_{bit}>2 may be bit-level scrambled, QPSK-modulated, and mapped to RB(s) of one or two OFDM symbols. Here, the number of RBs may be one of 1 to 16.

A PUCCH format 3 or a PUCCH format 4 may be capable of transmitting UCI exceeding 2 bits. The PUCCH format 3 or the PUCCH format 4 may be transmitted over consecutive OFDM symbols in the time domain and over one PRB in the frequency domain. The number of OFDM symbols occupied by the PUCCH format 3 or the PUCCH format 4 may be one of 4 to 14. More specifically, the terminal may modulate UCI when M_{bit}>2 with π/2-BPSK or QPSK to generate complex symbols d(0) to d(M_{symb}−1). When π/2-BPSK is used, M_{symb} may be equal to M_{bit}, and when QPSK is used, M_{symb} may be equal to M_{bit}/2. The terminal may not apply block-wise spreading to the PUCCH format 3. However, the terminal may apply block-wise spreading to one RB (i.e. 12 subcarriers) using a length-12 PreDFT-OCC such that the PUCCH format 4 has a multiplexing capacity of 2 or 4. The terminal may perform transmit precoding (or DFT-precoding) on the spread signal and may map the spread signal to REs to transmit the spread signal.

The number of RBs occupied by the PUCCH format 2, the PUCCH format 3, or the PUCCH format 4 may be determined according to the length of the UCI transmitted by the terminal and a maximum code rate. When the terminal uses the PUCCH format 2, the terminal may transmit HARQ-ACK information and CSI together through a PUCCH. When the number of RBs that the terminal can transmit exceeds a maximum number of RBs available for the PUCCH format 2, the PUCCH format 3, or the PUCCH format 4, the terminal may not transmit some UCI information according to a priority of the UCI and may transmit only remaining UCI information.

The PUCCH format 1, the PUCCH format 3, or the PUCCH format 4 may be configured through RRC signaling to apply frequency hopping within a slot. When frequency hopping is configured, an RB index for frequency hopping may be configured by RRC signaling. When the PUCCH format 1, the PUCCH format 3, or the PUCCH format 4 is transmitted over N OFDM symbols in the time domain, a first hop may have floor(N/2) OFDM symbols and a second hop may have ceil(N/2) OFDM symbols. A FLOOR function may return an integer value by discarding a decimal part when a specified value includes the decimal part. A CEIL function may return a next integer value by always rounding up when a specified value includes a decimal part.

The PUCCH format 1, the PUCCH format 3, or the PUCCH format 4 may be configured for repeated transmission over a plurality of slots. A number K of slots in which the PUCCH is repeatedly transmitted may be configured by RRC signaling. The repeatedly transmitted PUCCH may start at the same OFDM symbol position within each slot and may have the same length. When any OFDM symbol of a slot in which the terminal should transmit the PUCCH is indicated as a DL symbol by RRC signaling, the terminal may not transmit the PUCCH in the corresponding slot and may defer transmission to a next slot.

Meanwhile, in the 3GPP NR system, a terminal may perform transmission and reception using a bandwidth less than or equal to that of a carrier or a cell. For this purpose, the terminal may be configured with bandwidth part(s) (BWP(s)) each comprising a portion of a continuous bandwidth within a bandwidth of a carrier. A terminal operating in TDD or an unpaired spectrum may be configured with up to four DL/UL BWP pairs in one carrier or cell. In addition, the terminal may activate one DL/UL BWP pair.

A terminal operating in FDD or a paired spectrum may be configured with up to four DL BWPs in a DL carrier (or a cell) and may be configured with up to four UL BWPs in a UL carrier (or a cell). The terminal may activate one DL BWP and one UL BWP for each carrier or cell. The terminal may not receive or transmit in a time-frequency resource other than an activated BWP. The activated BWP may be referred to as an active BWP.

The base station may indicate an active BWP among configured BWPs of the terminal through DCI. The BWP indicated through the DCI may be activated, and other configured BWPs may be deactivated. In a carrier or a cell operating in TDD, the base station may include, in DCI for scheduling a PDSCH or a PUSCH, a bandwidth part indicator (BPI) indicating a BWP to be activated to change a DL/UL BWP pair of the terminal.

The terminal may receive DCI scheduling a PDSCH or a PUSCH and may identify the DL/UL BWP pair to be activated based on the BPI. For a DL carrier (or a cell) operating in FDD, the base station may include, in DCI scheduling a PDSCH, a BPI indicating a BWP to be activated in order to change a DL BWP of the terminal. For a UL carrier (or a cell) operating in FDD, the base station may include, in DCI scheduling a PUSCH, a BPI indicating a BWP to be activated in order to change a UL BWP of the terminal.

Carrier aggregation may refer to a scheme where a wireless communication system uses a wider frequency band by using multiple frequency blocks (or logical cells) composed of UL resources (or component carriers) and/or DL resources (or component carriers) by a terminal as a single logical frequency band. One component carrier may also be referred to as a primary cell (PCell), a secondary cell (SCell), or a primary SCell (PSCell). However, hereinafter, for convenience of description, the term ‘component carrier’ will be used uniformly.

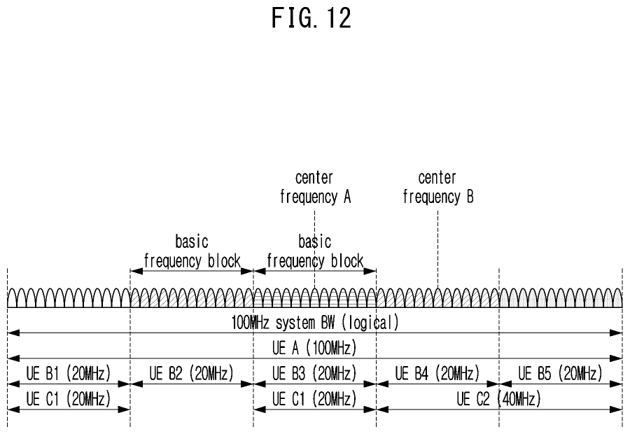

FIG. 12 is a conceptual diagram illustrating exemplary embodiments of carrier aggregation.

Referring to FIG. 12, as an example in a 3GPP NR system, the entire system bandwidth may include up to 16 component carriers, and each component carrier may have a bandwidth of up to 400 MHz. A component carrier may include one or more physically contiguous subcarriers. In FIG. 12, each component carrier is illustrated as having the same bandwidth, but this is only an example, and each component carrier may have a different bandwidth. In addition, component carriers are illustrated as being adjacent to each other in the frequency domain, but the drawing illustrates a logical concept, and component carriers may be physically adjacent or may be separated.

Different center frequencies may be used in component carriers. In addition, a common center frequency may be used in physically adjacent component carriers. In the exemplary embodiment of FIG. 12, when it is assumed that all component carriers are physically adjacent, a center frequency A may be used in all component carriers. When it is assumed that each component carrier is not physically adjacent, a center frequency A and a center frequency B may be used in respective component carriers.

When the entire system bandwidth is expanded by carrier aggregation, a frequency band used for communication with each terminal may be defined in units of component carriers. For example, a terminal A may use the entire system bandwidth of 100 MHz and may perform communication using all five component carriers. Terminals B1 to B5 may use only a 20 MHz bandwidth and may perform communication using one component carrier. Terminals C1 and C2 may use a bandwidth of 40 MHz and may perform communication using two component carriers, respectively. The two component carriers may be logically or physically adjacent or may not be adjacent. In the exemplary embodiment of FIG. 12, the terminal C1 may use two non-adjacent component carriers, and the terminal C2 may use two adjacent component carriers.

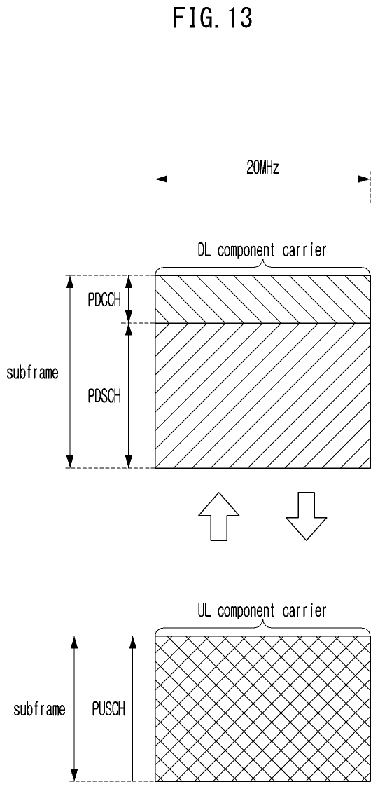

FIG. 13 is a conceptual diagram illustrating exemplary embodiments of single carrier communication.

Referring to FIG. 13, in an FDD mode, a wireless communication system may perform data transmission or reception through one DL band and one corresponding UL band. In another exemplary embodiment, in the case of a TDD mode, the wireless communication system may divide a radio frame into UL and DL time units in the time domain, and may perform data transmission or reception through the UL/DL time units.

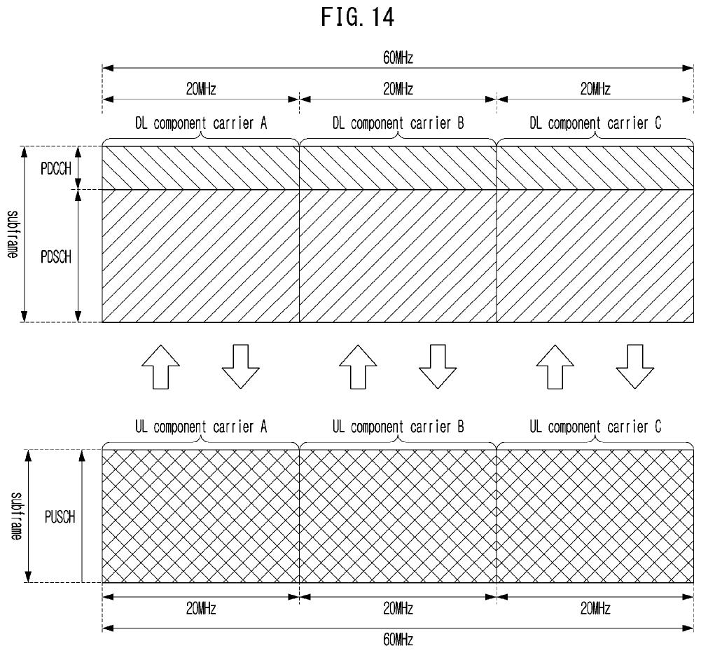

FIG. 14 is a conceptual diagram illustrating exemplary embodiments of multi-carrier communication.

Referring to FIG. 14, three 20 MHz component carriers (CCs) may be aggregated for both UL and DL to support a bandwidth of 60 MHz. The CCs may be adjacent or non-adjacent to each other in the frequency domain. For convenience, a case in which a bandwidth of a UL CC and a bandwidth of a DL CC are the same (i.e. symmetric) is illustrated in FIG. 14, but a bandwidth of each CC may be independently determined. Asymmetric carrier aggregation in which a number of UL CCs and a number of DL CCs are different may also be possible. A DL/UL CC allocated or configured to a specific terminal through RRC signaling may be referred to as a serving DL/UL CC for the terminal.

A base station may perform communication with the terminal by activating some or all of serving CCs of the terminal or deactivating some CCs. The base station may change which CCs are activated or deactivated and may change a number of CCs to be activated or deactivated. When the base station allocates CCs available to the terminal in a cell-specific or terminal-specific manner, at least one of allocated CCs may not be deactivated unless the CC allocation is completely reconfigured or the terminal performs a handover. A CC that is not deactivated may be referred to as a primary CC (PCC) or a PCell, and a CC that can be freely activated or deactivated by the base station may be referred to as a secondary CC (SCC) or an SCell.

Meanwhile, the 3GPP NR system may use the concept of a cell to manage radio resources. A cell may be defined as a combination of DL resources and UL resources, that is, a combination of a DL CC and a UL CC. The cell may be composed of only DL resources or a combination of DL resources and UL resources. When carrier aggregation is supported, association between a carrier frequency of DL resources (or a DL CC) and a carrier frequency of UL resources (or a UL CC) may be indicated by system information. The carrier frequency may indicate a center frequency of each cell or CC.

A cell corresponding to a PCC may be referred to as a PCell, and a cell corresponding to an SCC may be referred to as an SCell. In the downlink, a carrier corresponding to the PCell may be a DL PCC, and in uplink, a carrier corresponding to the PCell may be a UL PCC. Similarly, in downlink, a carrier corresponding to the SCell may be a DL SCC, and in the uplink, a carrier corresponding to the SCell may be a UL SCC. According to the terminal capability, serving cell(s) may be composed of one PCell and zero or more SCells. In the case of a terminal in an RRC connected state (i.e. RRC_CONNECTED state) but in which carrier aggregation is not configured or supported, there may be only one serving cell composed only of a PCell.

As described above, the term ‘cell’ used in carrier aggregation may be distinguished from the term ‘cell’ referring to a geographical area in which a communication service is provided by one base station or one antenna group. That is, one component carrier may also be referred to as a scheduling cell, a scheduled cell, a PCell, an SCell, or a PSCell. However, in the present disclosure, in order to distinguish a geographical cell from a cell of carrier aggregation, a cell of carrier aggregation may be referred to as a CC, and a cell of a geographical area may be referred to as a cell.

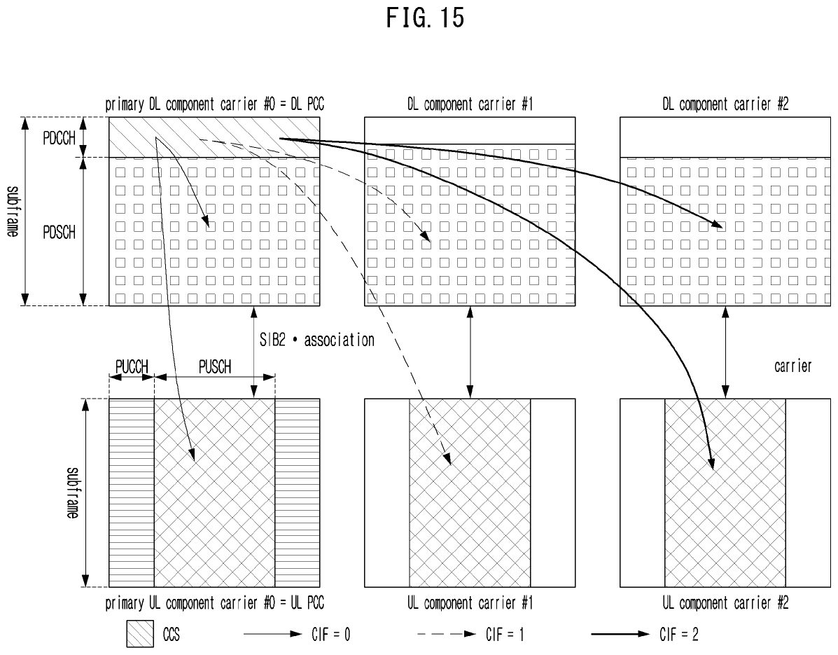

FIG. 15 is a conceptual diagram illustrating exemplary embodiments of a cross-carrier scheduling method.

Referring to FIG. 15, when cross-carrier scheduling is configured, a control channel transmitted on a first CC may schedule a data channel transmitted on the first CC or a second CC using a carrier indicator field (CIF). The CIF may be included in DCI. In other words, a scheduling cell may be configured, and a DL grant or a UL grant transmitted in a PDCCH region of the scheduling cell may schedule a PDSCH or a PUSCH of a scheduled cell. A search region corresponding to multiple component carriers may exist in the PDCCH region of the scheduling cell. A PCell may serve as a scheduling cell, and a specific SCell may be designated as a scheduling cell by higher-layer signaling.

In the exemplary embodiment of FIG. 15, it is assumed that three DL CCs are aggregated. A DL component carrier #0 may be assumed to be a DL PCC (or a PCell), and DL component carriers #1 and #2 may is assumed to be DL SCCs (or SCells). It may be assumed that the DL PCC is configured as a PDCCH monitoring CC. When cross-carrier scheduling is not configured by terminal-specific (or terminal-group-specific or cell-specific) higher-layer signaling, the CIF may be disabled, and each DL CC may transmit only a PDCCH scheduling its own PDSCH without the CIF according to NR PDCCH rules (i.e. non-cross-carrier scheduling or self-carrier scheduling).

On the other hand, when cross-carrier scheduling is configured by terminal-specific (or terminal-group-specific or cell-specific) higher-layer signaling, the CIF may be enabled, and a specific CC (e.g. the DL PCC) may transmit not only a PDCCH that schedules a PDSCH of DL CC A using the CIF but also a PDCCH that schedules a PDSCH of another DL CC (i.e. cross-carrier scheduling).

On the other hand, a PDCCH may not be transmitted in another DL CC. Accordingly, the terminal may receive a self-carrier scheduled PDSCH by monitoring a PDCCH that does not include the CIF or may receive a cross-carrier scheduled PDSCH by monitoring a PDCCH that includes the CIF depending on whether cross-carrier scheduling is configured for the terminal.

Meanwhile, FIG. 13, FIG. 14, and FIG. 15 illustrate a subframe structure of a 3GPP LTE-A system, but the same or similar configuration may be applied to the 3GPP NR system. However, in the 3GPP NR system, the subframes of FIG. 13, FIG. 14, and FIG. 15 may be replaced with slots.

A terminal may be implemented as various types of wireless communication devices or computing devices that provide portability and mobility. The terminal may be referred to as a user equipment (UE), a station (STA), a mobile subscriber (MS), and the like. A base station may control and manage a cell corresponding to a service area (e.g. a macro cell, a femto cell, or a pico cell), and may perform functions such as signal transmission, channel assignment, channel monitoring, self-diagnosis, and relaying. The base station may be referred to as a next generation NodeB (gNB) or an access point (AP).

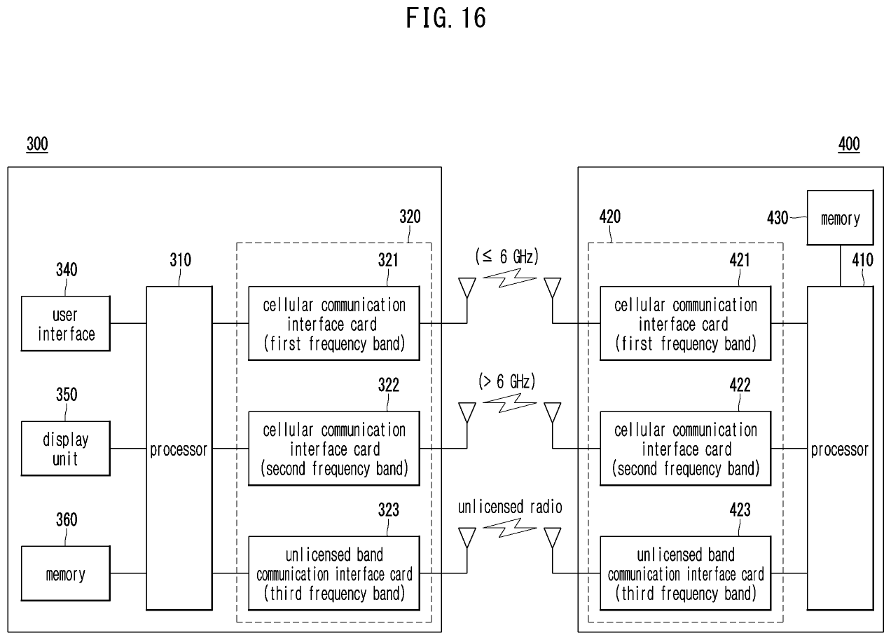

FIG. 16 is a block diagram illustrating exemplary embodiments of a terminal and a base station.

Referring to FIG. 16, a terminal 300 may include a processor 310, a communication module 320, a memory 330, a user interface unit 340, and a display unit 350.

The processor 310 may execute various commands or programs and may process data inside the terminal 300. In addition, the processor 310 may control an overall operation including respective components of the terminal 300 and may control transmission and reception of data between the units. Here, the processor 310 may be configured to perform operations according to exemplary embodiments described in the present disclosure. For example, the processor 310 may receive slot configuration information, may determine a slot configuration based on the slot configuration information, and may perform communication according to the determined slot configuration.

The communication module 320 may be an integrated module that performs wireless communication using a wireless communication network and wireless LAN access. For this purpose, the communication module 320 may include a plurality of network interface cards (NICs) such as cellular communication interface cards 321 and 322 and an unlicensed band communication interface card 323 internally or externally. Although the communication module 320 is illustrated as an integrated module in the drawing, each network interface card may be independently arranged according to a circuit configuration or a use, as opposed to the illustration.

The cellular communication interface card 321 may transmit and receive a wireless signal with at least one of a base station 400, an external device, or a server using a mobile communication network, and may provide a cellular communication service using a first frequency band based on a command from the processor 310. According to an exemplary embodiment, the cellular communication interface card 321 may include at least one NIC module using a frequency band lower than 6 GHz. The at least one NIC module of the cellular communication interface card 321 may perform cellular communication with at least one of the base station 400, the external device, or the server independently according to a cellular communication standard or protocol of the frequency band lower than 6 GHz supported by the NIC module.

The cellular communication interface card 322 may transmit and receive a wireless signal with at least one of the base station 400, the external device, or the server using a mobile communication network, and may provide a cellular communication service using a second frequency band based on a command from the processor 310. According to an exemplary embodiment, the cellular communication interface card 322 may include at least one NIC module using a frequency band higher than 6 GHz. The at least one NIC module of the cellular communication interface card 322 may perform cellular communication with at least one of the base station 400, the external device, or the server independently according to a cellular communication standard or protocol of the frequency band higher than 6 GHz supported by the NIC module.

The unlicensed band communication interface card 323 may transmit and receive a wireless signal with at least one of the base station 400, the external device, or the server using a third frequency band (i.e. an unlicensed band), and may provide a communication service in the unlicensed band based on a command of the processor 310. The unlicensed band communication interface card 323 may include at least one NIC module using an unlicensed band. For example, the unlicensed band may include bands such as 2.4 GHz, 5 GHz, 6 GHz, 7 GHz, or 52.6 GHz or higher. The at least one NIC module of the unlicensed band communication interface card 323 may perform wireless communication with at least one of the base station 400, the external device, or the server independently or in coordination according to an unlicensed band communication standard or protocol of the frequency band supported by the NIC module.

The memory 330 may store a control program used in the terminal 300 and various data related thereto. The control program may include a predetermined program required for the terminal 300 to perform wireless communication with at least one of the base station 400, the external device, or the server.

The user interface 340 may include various types of input/output means provided in the terminal 300. The user interface 340 may receive a user input using various input means, and the processor 310 may control the terminal 300 based on the received user input. The user interface 340 may generate an output based on a command from the processor 310 using various output means.

The display unit 350 may output various images on a display screen. The display unit 350 may output various display objects such as content executed by the processor 310 or a user interface based on a control command from the processor 310. The base station 400 according to an exemplary embodiment of the present disclosure may include a processor 410, a communication module 420, and a memory 430.

The processor 410 may execute various commands or programs and may process data inside the base station 400. The processor 410 may control an overall operation including respective components of the base station 400 and may control transmission and reception of data between the units. The processor 410 may be configured to perform operations according to exemplary embodiments described in the present disclosure. For example, the processor 410 may signal slot configuration information and may perform communication according to the signaled slot configuration.

The communication module 420 may be an integrated module that performs wireless communication using a wireless communication network and wireless LAN access. For this purpose, the communication module 420 may include a plurality of NICs internally or externally, such as cellular communication interface cards 421 and 422 and an unlicensed band communication interface card 423. Although the communication module 420 is illustrated as an integrated module in the drawing, each NIC may be independently arranged according to a circuit configuration or a use, as opposed to the illustration.

The cellular communication interface card 421 may transmit and receive a wireless signal with at least one of the terminal 300 described above, an external device, or a server using a mobile communication network, and may provide a cellular communication service using a first frequency band based on a command from the processor 410. According to an exemplary embodiment, the cellular communication interface card 421 may include at least one NIC module using a frequency band lower than 6 GHz. The at least one NIC module of the cellular communication interface card 421 may perform cellular communication with at least one of the terminal 300, the external device, or the server independently according to a cellular communication standard or protocol of the frequency band lower than 6 GHz supported by the NIC module.

The cellular communication interface card 422 may transmit and receive a wireless signal with at least one of the terminal 300, the external device, or the server using a mobile communication network, and may provide a cellular communication service using a second frequency band based on a command from the processor 410. According to an exemplary embodiment, the cellular communication interface card 422 may include at least one NIC module using a frequency band of 6 GHz or higher. The at least one NIC module of the cellular communication interface card 422 may perform cellular communication with at least one of the terminal 300, the external device, or the server independently based on a cellular communication standard or protocol of the frequency band of 6 GHz or higher supported by the NIC module.

The unlicensed band communication interface card 423 may transmit and receive a wireless signal with at least one of the terminal 300, the external device, or the server using a third frequency band (i.e. an unlicensed band), and may provide a communication service in the unlicensed band based on a command from the processor 410. The unlicensed band communication interface card 423 may include at least one NIC module using an unlicensed band. For example, the unlicensed band may be bands such as 2.4 GHz, 5 GHz, 6 GHz, 7 GHz, or 52.6 GHz or higher. The at least one NIC module of the unlicensed band communication interface card 423 may perform wireless communication with at least one of the terminal 300, the external device, or the server independently or in coordination according to an unlicensed band communication standard or protocol of the frequency band supported by the NIC module.

The units of the terminal 300 and the base station 400 illustrated in FIG. 16 as separate blocks may represent elements of each device logically distinguished. Accordingly, the above-described elements of the device may be mounted as one chip or a plurality of chips according to a design of the device. In addition, some components of the terminal 300, for example the user interface 340 and the display unit 350, may be optionally provided in the terminal 300. In addition, the user interface 340 and the display unit 350 may be additionally provided in the base station 400 as needed.

Meanwhile, the terminal may use intelligent technologies (e.g. AI/ML) at a radio interface for beam management, positioning accuracy enhancement, CSI feedback enhancement, and the like. Since the intelligent technology used in a wireless communication network is based on training data, the terminal may perform life cycle management (LCM) for generating and maintaining an intelligent functionality or a model in response to changes in training data.

For example, an LCM process performed by the terminal or related entities may include detailed components such as data collection, model training, model inference using the model, model deployment, model activation, model deactivation, model selection, model switching, model fallback, and model monitoring.

For example, in a mobile communication system, the terminal and related entities may generate a specific intelligent model through model training after performing data collection. For example, in the mobile communication system, the terminal and the like may perform model deployment and/or activation of the generated model. For example, in the mobile communication system, the terminal and the like may perform operations using a model inference process using the generated model and may manage the generated model through a model monitoring process.

The present disclosure may classify types of AI/ML models as follows according to a location of a network node where an inference operation of an intelligent model or an AI/ML model is performed. For example, an AI/ML model in which model inference is entirely performed at a terminal or a network may be classified as a one-sided AI/ML model. More specifically, in the one-sided AI/ML model, when the model inference process is performed at a terminal, the model may be classified as a UE-sided AI/ML model.

More specifically, in the one-sided AI/ML model, when the model inference process is performed in a network, the model may be classified as a network-sided AI/ML model. For example, a pair of AI/ML models in which joint inference is performed may be classified as a two-sided AI/ML model. Here, the joint inference may include inference performed jointly across a terminal and a network.

More specifically, the joint inference may include a case where a first part of inference is performed by a terminal and a remaining part is performed by a base station or a network. The joint inference may include a case where a first part of inference is performed by a base station or a network and a remaining part is performed by a terminal.

In a mobile communication system, a terminal and a base station may use an intelligent functionality and a model, and may perform functionality identification and model identification supported by a network before performing LCM. For example, the base station may identify which intelligent functionality and model the terminal can support and may instruct activation of a specific intelligent functionality and model in the terminal based on the identified intelligent functionality and model.

In relation to the intelligent functionality and model identification, the terminal and/or the base station may perform two types of LCM. For example, the terminal and the base station may perform model ID-based LCM. The model ID-based LCM may indicate an LCM process in which the base station or a base station-side server and the terminal or a terminal-side server share information on an intelligent model together with a model ID in advance, and thereafter identify and manage the intelligent model using the model ID.

For example, the terminal and the base station may perform functionality-based LCM. The functionality-based LCM may indicate an LCM process in which the base station or a base station-side server and the terminal or a terminal-side server share functionality information for an intelligent functionality in advance, and thereafter identify and manage the intelligent functionality using a function name or a function ID. The model-based LCM and the functionality-based LCM may be independently configured or may be configured in a mixed form without independent configuration.

In a mobile communication network, a transmitter may perform encoding of a data signal, power allocation, and beamforming using multiple transmit antennas in order to perform data transmission to a receiver. For this purpose, the transmitter may acquire information on a radio channel between antennas of the transmitter and the receiver. The transmitter may not directly observe a channel from the transmitter to the receiver. Therefore, the transmitter may require a CSI reporting procedure. The CSI reporting procedure may be a procedure of reporting channel information measured by the receiver to the transmitter. The CSI may be information for scheduling data transmission from the transmitter to the receiver. The CSI may include at least one of a rank, a channel quality index (CQI), or precoding information.

A reference signal such as a CSI-RS may be used to measure a channel at the receiver. The transmitter may transmit the CSI-RS to the receiver periodically or aperiodically. The transmitter may configure transmission-related information in advance so that the receiver can receive the CSI-RS. In the CSI reporting procedure, the receiver may receive the CSI-RS from the transmitter, may generate CSI, and may transmit the generated CSI to the transmitter. The transmitter may receive the CSI from the receiver. The amount of channel information may be very large in order to accurately represent the channel information. Such a large amount of channel information may increase the use of radio transmission resources and overhead, thereby degrading system performance. In particular, when channel information for expressing a channel change for allowing the receiver to determine precoding at the transmitter or precoding information for recommending an appropriate precoding vector to the transmitter is accurately represented, a large overhead may be caused.

In an NR massive MIMO system, it may be very important in physical layer operation that the transmitter obtains an accurate CSI report at an appropriate time. The transmitter may require very frequent CSI reporting in order to obtain a CSI report at a desired time. Frequent CSI reporting from the receiver to the transmitter may cause large overhead. For example, the CSI reporting procedure may be performed with a periodicity of 40 ms in the 5G NR network. A large number of events may occur in a radio channel during a periodic CSI reporting period. The most recent CSI report received by the base station (e.g. gNB) may not be appropriate for use in the near future.

In order to solve such a channel aging problem, a mobile communication system may use an AI/ML algorithm for CSI prediction. Channel aging may indicate a delay between a time at which CSI is reported and a time at which a gNB uses the CSI. Such a delay may cause severe performance degradation as the terminal speed increases. AI/ML-based CSI prediction may mitigate the effect of outdated CSI that may not be accurate by predicting a future CSI state, and thus may improve communication performance by enabling more accurate and appropriate adjustment in the wireless network.

When the terminal performs CSI prediction using a UE-sided AI/ML model, the terminal may continuously monitor in order to maintain model performance of the AI/ML model. In certain environments, performance of the AI/ML model may decrease. In such a situation, when the transmitter or the receiver continues to use the AIML model, performance degradation may occur. More specifically, when performance of the AI/ML model decreases, AI/ML-based CSI prediction may produce inaccurate results. When performance of the AI/ML model decreases, not only a channel aging problem may not be resolved, but also may cause throughput degradation by providing inaccurate information.

In order to solve such a problem, the present disclosure proposes an AI/ML model monitoring process when CSI prediction is performed using a UE-sided AI/ML model. A model monitoring process of the UE-sided AI/ML model performing CSI prediction may be classified into four steps. A first step of the model monitoring process may be receiving a CSI-RS at the terminal for AI/ML performance monitoring. The terminal may receive the CSI-RS to estimate a channel and CSI, and may predict a future channel and/or CSI based on the channel and CSI. In addition, the terminal may receive a CSI-RS for intelligent model monitoring for AI/ML model monitoring, and may obtain ground-truth data for a channel and/or CSI through the received CSI-RS.

A second step may be calculating a performance metric based on measured data and the channel predicted by the AI/ML model at the terminal. A third step may be reporting a result of the AI/ML model based on the performance metric from the terminal to the base station. A last step may be determining an operation of the UE-sided AI/ML model at the base station based on a report from the terminal. A detailed description of each step may be as follows.

First, the first step may be receiving a downlink reference signal at the terminal. The base station may configure channel measurement resources (CMR) for channel measurement for the terminal using higher-layer parameters (e.g. RRC parameters). For example, the base station may configure the CMR for the terminal using an information element (IE) within CSI report configuration information (e.g. CSI-ReportConfig). The terminal may measure a channel based on the CMR. The terminal may transmit a CSI report to the base station using a configuration for CSI reporting. The base station may receive the CSI report from the terminal. The UE-sided AI/ML model may predict future CSI using channel measurement results obtained via the CMR.

The base station may configure monitoring measurement resources (MMR), which are DL reference signals for monitoring, to collect measured data to be compared with the CSI prediction result in order to perform AI/ML model monitoring. In such a case, the base station may configure the MMR separately from the CMR or may configure the CMR and the MMR at once.

For example, the base station may configure the CMR and the MMR separately. In such a case, the base station may configure the MMR with a specific periodicity, and may transmit the MMR to the terminal in a periodic manner or a semi-persistent manner. The base station may separately configure the MMR using an RRC parameter or the like. The base station may configure the terminal to report a performance metric or a performance metric result as a monitoring-related report using other configuration information (e.g. OtherConfig) or CSI report configuration information (e.g. CSI-ReportConfig).

When the MMR is configured for the terminal through CSI report configuration information (e.g. CSI-ReportConfig), a new IE for reporting a performance metric or a performance metric result may be added. The IE may define time-frequency resources for reporting the performance metric or the performance metric result of the terminal. When the base station configures the terminal to report the performance metric result, the base station may configure a specific threshold in the IE. The threshold may be a value representing a difference between measured data and a CSI prediction value of the AI/ML model. Alternatively, the threshold may be a value representing similarity between measured data and a CSI prediction value of the AI/ML model. The terminal may receive a configuration to report the performance metric result from the base station. The terminal may report the performance metric or the performance metric result to the base station.

The base station may configure the CMR and the MMR together. In such a case, the base station may configure the MMR with a specific periodicity and may transmit the MMR to the terminal in a periodic manner or a semi-persistent manner. The base station may configure the MMR separately from the CMR using an RRC parameter or the like. In such a case, the base station may configure the terminal to report a performance metric or a performance metric result as a monitoring report using CSI report configuration information (e.g. CSI-ReportConfig). The terminal may receive a configuration to report a performance metric or a performance metric result as a monitoring-related report from the base station. The terminal may report the performance metric or the performance metric result for monitoring to the base station. The MMR may be configured to the terminal through CSI report configuration information (e.g. CSI-ReportConfig).

In such a case, the base station may add a new IE for reporting a performance metric or a performance metric result. The new IE may define time-frequency resources for reporting the performance metric or the performance metric result of the terminal. In addition, when the base station configures the terminal to report the performance metric result, the base station may configure a specific threshold in the new IE. The specific threshold may be a value related to a difference between measured data and a CSI prediction value of the AI/ML model. The specific threshold may be a value related to similarity between measured data and a CSI prediction value of the AIML model. The terminal may receive configuration for reporting the performance metric or the performance metric result. The terminal may report at least one of a CSI report for the CMR, a performance metric report, or a performance metric result to the base station.

In the CSI prediction process using the AI/ML model, the second step for model monitoring may be calculating a performance metric based on measured data and a CSI prediction value generated by the AI/ML model at the terminal. The terminal may calculate the performance metric based on the measured data and the CSI predicted by the AI/ML model. The terminal may use a squared generalized cosine similarity (SGCS) as the performance metric.

More specifically, the terminal may use, as the performance metric, an SGCS between a precoder corresponding to a PMI predicted by the AI/ML model and a precoder corresponding to a PMI obtained from measured data. The terminal may determine the SGCS for each subband in which the terminal operates. The terminal may determine the SGCS for each layer in which the terminal operates. The terminal may determine the SGCS for each prediction instance in which the terminal operates.

In the CSI prediction process using the AI/ML model, the third step for model monitoring may be reporting a result of the AI/ML model based on the performance metric from the terminal to the base station. The base station may instruct the terminal to report only the performance metric. The terminal may receive an instruction to report only the performance metric from the base station. The terminal may report the calculated performance metric to the base station. The base station may receive the performance metric from the terminal.

The base station may instruct the terminal to report a performance metric result. The terminal may receive an instruction to report the performance metric result from the base station. The terminal may determine the performance metric result by comparing the calculated performance metric with a preconfigured threshold. For example, the base station may configure a specific threshold value related to the SGCS for the terminal. In such a case, an SGCS value between a channel obtained by receiving the MMR at the terminal and a channel predicted by the AI/ML model may be less than the threshold or may be less than or equal to the threshold. In this case, the terminal may report, as the performance metric result, a comparison result indicating that the SGCS value is less than or equal to the specific threshold to the base station. The base station may receive the performance metric result including a comparison result indicating that the SGCS value is less than or equal to the specific threshold from the terminal.

The base station may configure the threshold value for the terminal. In such a case, the base station may configure the threshold value for the terminal using a higher-layer parameter such as an RRC parameter. For example, the base station may configure a set of candidate threshold values. The base station may select an appropriate threshold value from the set depending on the situation and may configure the threshold value for the terminal. Alternatively, the base station may directly configure an appropriate threshold value to the terminal.

When the terminal reports SGCS to the base station, the terminal may determine SGCS for each subband. The terminal may determine an average SGCS value for each subband. The terminal may report the average value of the SGCS for each subband to the base station. The base station may receive the average SGCS value for each subband from the terminal. When the terminal reports SGCS to the base station, the terminal may determine SGCS for each prediction instance. The terminal may determine an average SGCS value for each prediction instance.

The terminal may report the average SGCS value for each prediction instance to the base station. The base station may receive the average SGCS value for each prediction instance from the terminal. When the terminal reports SGCS to the base station, the terminal may determine SGCS for each layer. The terminal may report all SGCS values for the layers to the base station. The base station may receive all SGCS values for the layers from the terminal.

When the terminal reports SGCS to the base station, the terminal may report the determined SGCS to the base station. The base station may receive the determined SGCS from the terminal. In order for the terminal to report SGCS to the base station, the base station may configure, for the terminal through an RRC parameter or the like, range intervals for SGCS values. That is, the base station may transmit, to the terminal, information on an interval table to be used when reporting SGCS values. For example, the base station may transmit CSI report configuration information (e.g. CSI-ReportConfig) including information on the interval table to the terminal.

The terminal may receive the CSI report configuration information (e.g. CSI-ReportConfig) including the information on the interval table from the base station. The base station may transmit, to the terminal, UE assistance information (UAI) including the information on the interval table. The terminal may receive the UAI including the information on the interval table from the base station. Alternatively, the base station may transmit, to the terminal, other configuration information (e.g. OtherConfig) including the information on the interval table. The terminal may receive the other configuration including the information on the interval table from the base station.

For example, when an SGCS value has a value between 0 and 1, the base station may transmit an interval table as shown in Table 5 below to the terminal.

TABLE 5

| Interval number | |
|---|---|
| (or interval index) | Range interval |
| First interval | 0.0 or more and less than 0.25 |
| Second interval | 0.25 or more and less than 0.5 |
| Third interval | 0.5 or more and less than 0.75 |
| Fourth interval | 0.75 or more and less than or equal to 1.0 |

In order for the terminal to report SGCS to the base station, the base station may configure, for the terminal through an RRC parameter or the like, range intervals for SGCS values. For example, the base station may transmit, to the terminal, information on an interval table to be used when reporting SGCS values. The base station may transmit CSI report configuration information (e.g. CSI-ReportConfig) including the information on the interval table to the terminal.

The terminal may receive the CSI report configuration information (e.g. CSI-ReportConfig) including the information on the interval table from the base station. The base station may transmit UAI including the information on the interval table to the terminal. The terminal may receive the UAI including the information on the interval table from the base station. Alternatively, the base station may transmit other configuration information (e.g. OtherConfig) including the information on the interval table to the terminal. The terminal may receive the other configuration information including the information on the interval table from the base station.

As another example, the base station may transmit, to the terminal, information on the number of uniform intervals for the interval table to be used when reporting SGCS values. The number of uniform range intervals may be information indicating, to the terminal, into how many intervals a range between 0 and 1 is uniformly divided.

The base station may transmit CSI report configuration information (e.g. CSI-ReportConfig) including the information on the number of uniform range intervals for the interval table to the terminal. The terminal may receive the CSI report configuration information (e.g. CSI-ReportConfig) including the information on the number of uniform range intervals for the interval table from the base station. The base station may transmit UAI including the information on the number of uniform range intervals for the interval table to the terminal.

The terminal may receive the UAI including the information on the number of uniform range intervals for the interval table from the base station. Alternatively, the base station may transmit other configuration information (e.g. OtherConfig) including the information on the number of uniform range intervals for the interval table to the terminal. The terminal may receive the other configuration information including the information on the number of uniform range intervals for the interval table from the base station. The terminal may generate the interval table based on the number of uniform range intervals.

As another example, the base station may transmit, to the terminal, information on a range interval size for an interval table to be used when reporting SGCS values. The range interval size may be information indicating, to the terminal, an interval used to uniformly divide a range between 0 and 1. The base station may transmit CSI report configuration information (e.g. CSI-ReportConfig) including the information on the range interval size for the interval table to the terminal.

The terminal may receive the CSI report configuration information (e.g. CSI-ReportConfig) including the information on the range interval size for the interval table from the base station. The base station may transmit UAI including the information on the range interval size for the interval table to the terminal. The terminal may receive the UAI including the information on the range interval size for the interval table from the base station. Alternatively, the base station may transmit other configuration information (e.g. OtherConfig) including the information on the range interval size for the interval table to the terminal. The terminal may receive the other configuration including the information on the range interval size for the interval table from the base station. The terminal may generate the interval table based on the range interval size.

The terminal may identify a range interval in the interval table to which the determined SGCS belongs and may report, to the base station, an interval number or an interval index corresponding to the identified range interval. The number of range intervals of the interval table may be n, and n may be a natural number. In this case, the terminal may report the interval number or the interval index to the base station using ceil(log₂ n) bits. A CEIL function may return a next integer value by always rounding up a specified value when the specified value includes a decimal part. The base station may receive the interval number or the interval index corresponding to the identified range interval from the terminal.

When the terminal reports SGCS to the base station, the terminal may report the determined SGCS to the base station. In order for the terminal to report SGCS to the base station, 3GPP specifications may predefine range intervals of an interval table for SGCS values and interval numbers or interval indices for the range intervals. The terminal may determine a range interval including the determined SGCS in the predefined interval table specified in 3GPP specifications. The terminal may report the interval index corresponding to the determined range interval to the base station.

More specifically, 3GPP specifications may define the range intervals for the SGCS value as a look-up table. The terminal may determine a range interval including the determined SGCS in the look-up table. The terminal may report an interval index corresponding to the determined range interval in the look-up table to the base station. The number of range intervals of the predefined look-up table may be n, and n may be a natural number. The terminal may report to the base station using ceil(log₂ n) bits whenever the terminal reports SGCS. The base station may receive the interval number or the interval index corresponding to the identified range interval from the terminal.

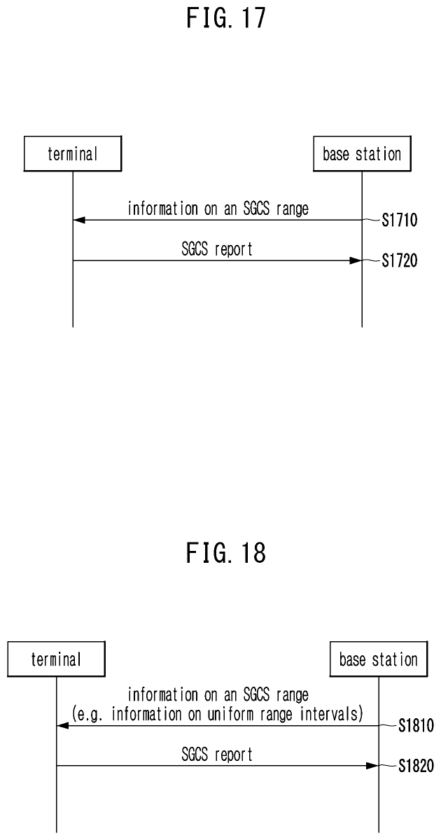

FIG. 17 is a sequence diagram illustrating an exemplary embodiment of a method for reporting a monitoring result of an intelligent model.

Referring to FIG. 17, the base station may transmit, to the terminal, information on an SGCS range to be used when reporting an SGCS value (e.g. information on an interval table) (S1710). For example, the base station may transmit CSI report configuration information (e.g. CSI-ReportConfig) including the information on the SGCS range (e.g. the information on the interval table) to the terminal. The terminal may receive the CSI report configuration information (e.g. CSI-ReportConfig) including the information on the SGCS range (e.g. the information on the interval table) from the base station.

The base station may transmit, to the terminal, UAI including the information on the SGCS range (e.g. the information on the interval table). The terminal may receive, from the base station, the UAI including the information on the SGCS range (e.g. the information on the interval table). Alternatively, the base station may transmit, to the terminal, other configuration information (e.g. OtherConfig) including the information on the SGCS range (e.g. the information on the interval table). The terminal may receive, from the base station, the other configuration information (e.g. OtherConfig) including the information on the SGCS range (e.g. the information on the interval table).

For example, the base station may transmit an interval table as shown in Table 6 below to the terminal.

TABLE 6

| Interval number | |
|---|---|
| (or interval index) | Range interval |
| First interval | less than or equal to 0.85 |
| Second interval | greater than 0.85 and less |
| | than or equal to 0.90 |
| Third interval | greater than 0.90 and less |
| | than or equal to 0.95 |
| Fourth interval | greater than 0.95 |

A result value of SGCS determined at the terminal may be, for example, 0.94. The value 0.94 may belong to an interval greater than 0.90 and less than or equal to 0.95 and may correspond to the third interval in the interval table. The terminal may report, for example, an interval number 3 to the base station (S1720). The base station may receive the interval number 3 from the terminal. The terminal may report, for example, a bitmap ‘0010’ corresponding to the interval number 3 to the base station. The base station may receive, from the terminal, the bitmap ‘0010’ corresponding to the interval number 3. The base station may determine that the result value of SGCS determined at the terminal falls within the interval greater than 0.90 and less than or equal to 0.95.

FIG. 18 is a sequence diagram illustrating an exemplary embodiment of a method for reporting a monitoring result of an intelligent model.

Referring to FIG. 18, the base station may transmit, to the terminal, information indicating a number of uniform range intervals (e.g. 10) for an SGCS range to be used when reporting an SGCS value (e.g. information on uniform intervals and information on a uniform interval table) (S1810). The number of uniform range intervals may be information indicating, to the terminal, into how many intervals a range between 0 and 1 is uniformly divided. The base station may transmit, to the terminal, CSI report configuration information (e.g. CSI-ReportConfig) including the number of uniform range intervals for the SGCS range (e.g. information on uniform intervals and information on a uniform interval table).

The terminal may receive, from the base station, the CSI report configuration information (e.g. CSI-ReportConfig) including the number of uniform range intervals (e.g. 10) for the SGCS range (e.g. information on uniform intervals and information on a uniform interval table). The base station may transmit, to the terminal, UAI including the number of uniform range intervals (e.g. 10) for the SGCS range (e.g. information on uniform intervals and information on a uniform interval table).

The terminal may receive, from the base station, the UAI including the number of uniform range intervals (e.g. 10) for the SGCS range (e.g. information on uniform intervals and information on a uniform interval table). Alternatively, the base station may transmit, to the terminal, other configuration information (e.g. OtherConfig) including the number of uniform range intervals (e.g. 10) for the SGCS range (e.g. information on uniform intervals and information on a uniform interval table). The terminal may receive, from the base station, the other configuration information (e.g. OtherConfig) including the number of uniform range intervals (e.g. 10) for the SGCS range (e.g. information on uniform intervals and information on a uniform interval table). The terminal may generate an interval table as shown in Table 7 based on the number of uniform range intervals (e.g. 10) for the SGCS range (e.g. information on uniform intervals and information on a uniform interval table).

TABLE 7

| Interval number | |
|---|---|
| (or interval index) | Range interval |
| First interval | less than or equal to 0.1 |
| Second interval | greater than 0.1 and less than or equal to 0.2 |
| Third interval | greater than 0.2 and less than or equal to 0.3 |
| Fourth interval | greater than 0.3 and less than or equal to 0.4 |
| Fifth interval | greater than 0.4 and less than or equal to 0.5 |
| Sixth interval | greater than 0.5 and less than or equal to 0.6 |
| Seventh interval | greater than 0.6 and less than or equal to 0.7 |
| Eighth interval | greater than 0.7 and less than or equal to 0.8 |
| Ninth interval | greater than 0.8 and less than or equal to 0.9 |
| Tenth interval | greater than 0.9 |

A result value of SGCS determined at the terminal may be, for example, 0.94. The value 0.94 may belong to an interval greater than 0.90 and may correspond to the tenth interval in the interval table. The terminal may report, for example, an interval number 10 to the base station (S1820). The base station may receive the interval number 10 from the terminal. The terminal may report, for example, a bitmap ‘0000000001’ corresponding to the interval number 10 to the base station. The base station may receive, from the terminal, the bitmap ‘0000000001’ corresponding to the interval number 10.

The interval table may be configured in reverse order from Table 7. The terminal may report, for example, an interval number 1 to the base station. The base station may receive the interval number 1 from the terminal. The terminal may report, for example, a bitmap ‘1000000000’ corresponding to the interval number 1 to the base station. The base station may receive, from the terminal, the bitmap ‘1000000000’ corresponding to the interval number 1. The base station may determine that a result value of SGCS determined at the terminal falls within the interval greater than 0.90.

As another example, the base station may transmit, to the terminal, information on a range interval size (e.g. 0.1) for an interval table to be used when reporting an SGCS value. The range interval size may be information indicating, to the terminal, an interval used to uniformly divide a range between 0 and 1. The base station may transmit, to the terminal, CSI report configuration information (e.g. CSI-ReportConfig) including the information on the range interval size (e.g. 0.1) for the interval table.

The terminal may receive, from the base station, the CSI report configuration information (e.g. CSI-ReportConfig) including the information on the range interval size (e.g. 0.1) for the interval table. The base station may transmit, to the terminal, UAI including the information on the range interval size (e.g. 0.1) for the interval table.

The terminal may receive, from the base station, the UAI including the information on the range interval size (e.g. 0.1) for the interval table. Alternatively, the base station may transmit, to the terminal, other configuration information (e.g. OtherConfig) including the information on the range interval size (e.g. 0.1) for the interval table. The terminal may receive, from the base station, the other configuration information (e.g. OtherConfig) including the information on the range interval size (e.g. 0.1) for the interval table. The terminal may generate the interval table as shown in Table 7 based on the range interval (e.g. 0.1).

A result value of SGCS determined at the terminal may be, for example, 0.94. The value 0.94 may belong to an interval greater than 0.90 and may correspond to the tenth interval in the interval table. The terminal may report, for example, an interval number 10 to the base station. The base station may receive the interval number 10 from the terminal. The terminal may report, for example, a bitmap ‘0000000001’ corresponding to the interval number 10 to the base station. The base station may receive, from the terminal, the bitmap ‘0000000001’ corresponding to the interval number 10.

The interval table may be configured in reverse order from Table 7. The terminal may report, for example, an interval number 1 to the base station. The base station may receive the interval number 1 from the terminal. The terminal may report, for example, a bitmap ‘1000000000’ corresponding to the interval number 1 to the base station. The base station may receive, from the terminal, the bitmap ‘1000000000’ corresponding to the interval number 1. The base station may determine that a result value of SGCS determined at the terminal falls within the interval greater than 0.90.

When the terminal reports SGCS to the base station, the terminal may report a second SGCS (i.e. SGCS 2) together with a determined first SGCS (i.e. SGCS 1) to the base station. The second SGCS may be an SGCS obtained based on measured data at a first time and CSI corresponding to the most recent CSI-RS transmission occasion.

The CSI used for SGCS2 may be CSI obtained prior to a CSI reference resource of an inference reporting instance. For example, the terminal may use, as the first SGCS, an SGCS between a first precoder corresponding to a first PMI predicted by an AI/ML model for the first time (i.e. a time instance corresponding to the first time) and a second precoder corresponding to a second PMI obtained from measured data at the first time. The terminal may use, as the second SGCS, an SGCS between a third precoder corresponding to a third PMI based on a CSI-RS at a second time and the second precoder corresponding to the second PMI obtained from the measured data at the first time. The second time may precede the first time.

In other words, the terminal may determine the third PMI based on measurement of a CSI-RS corresponding to the most recent CSI-RS transmission occasion among CSI-RS transmission occasions that are not later than a CSI reference resource of a CSI prediction report corresponding to a first reporting setting. The reporting setting may be a configuration unit of a reporting rule that defines which CSI is reported by the terminal, based on which resource or time, and in which manner (e.g. periodic, semi-persistent, or aperiodic manner). The first reporting setting may be a CSI prediction reporting setting. The second reporting setting may be a setting for reporting a CSI performance metric result.

When the terminal reports SGCS1 to the base station, the terminal may determine SGCS1 for each subband. The terminal may determine an average SGCS1 value for each subband. The terminal may report the average SGCS1 value for each subband to the base station. The base station may receive the average SGCS1 value for each subband from the terminal. When the terminal reports SGCS1 to the base station, the terminal may determine SGCS1 for each prediction instance. The terminal may determine an average SGCS1 value for each prediction instance.

The terminal may report the average SGCS1 value for each prediction instance to the base station. The base station may receive the average SGCS1 value for each prediction instance from the terminal. When the terminal reports SGCS1 to the base station, the terminal may determine SGCS1 for each layer. The terminal may report all SGCS1 values for the layers to the base station. The base station may receive all SGCS1 values for the layers from the terminal.

When the terminal reports SGCS2 to the base station, the terminal may determine SGCS2 for each subband. The terminal may determine an average SGCS2 value for each subband. The terminal may report the average SGCS2 value for each subband to the base station. The base station may receive the average SGCS2 value for each subband from the terminal. When the terminal reports SGCS2 to the base station, the terminal may determine SGCS2 for each prediction instance. The terminal may determine an average SGCS2 value for each prediction instance.

The terminal may report the average SGCS2 value for each prediction instance to the base station. The base station may receive the average SGCS2 value for each prediction instance from the terminal. When the terminal reports SGCS2 to the base station, the terminal may determine SGCS2 for each layer. The terminal may report all SGCS2 values for the layers to the base station. The base station may receive all SGCS2 values for the layers from the terminal.

A result value of SGCS1 determined at the terminal may be, for example, 0.94. The value 0.94 may belong to an interval greater than 0.90 and may correspond to the tenth interval in the interval table. The terminal may report, for example, an interval number 10 as SGCS1 to the base station. The base station may receive the interval number 10 from the terminal. The terminal may report, for example, a bitmap ‘0000000001’ corresponding to the interval number 10 to the base station. The base station may receive, from the terminal, the bitmap ‘0000000001’ corresponding to the interval number 10.

A result value of SGCS2 determined at the terminal may be, for example, 0.85. The value 0.85 may belong to an interval greater than 0.80 and less than 0.90 and may correspond to the ninth interval in the interval table. The terminal may report, for example, an interval number 9 as SGCS2 to the base station. The base station may receive the interval number 9 from the terminal. The terminal may report, for example, a bitmap ‘0000000010’ corresponding to the interval number 9 to the base station. The base station may receive, from the terminal, the bitmap ‘0000000010’ corresponding to the interval number 9.

The terminal may report a difference between the first SGCS and the second SGCS to the base station. The base station may receive the difference between the first SGCS and the second SGCS from the terminal. The terminal may report the first SGCS and the second SGCS to the base station. The base station may receive the first SGCS and the second SGCS from the terminal. When the terminal reports the difference between the first SGCS and the second SGCS to the base station, the terminal may determine a difference between a bitmap corresponding to the larger SGCS value and a bitmap corresponding to the smaller SGCS value in a range interval. The terminal may report the difference between the bitmap corresponding to the larger SGCS value and the bitmap corresponding to the smaller SGCS value to the base station. The base station may receive the difference between the bitmap corresponding to the larger SGCS value and the bitmap corresponding to the smaller SGCS value from the terminal.

When the terminal reports the difference between the first SGCS and the second SGCS to the base station, the base station may configure, for the terminal through an RRC parameter or the like, range intervals for a difference obtained by subtracting the smaller SGCS value from the larger SGCS value. For example, the base station may transmit, to the terminal, information on an interval table to be used when reporting a difference (SGCS1-SGCS2) or (SGCS2-SGCS1) obtained by subtracting the smaller SGCS value from the larger SGCS value. The base station may transmit CSI report configuration information (e.g. CSI-ReportConfig) including the information on the interval table to the terminal.

The terminal may receive the CSI report configuration information (e.g. CSI-ReportConfig) including the information on the interval table from the base station. The base station may transmit UAI including the information on the interval table to the terminal. The terminal may receive the UAI including the information on the interval table from the base station. Alternatively, the base station may transmit other configuration information (e.g. OtherConfig) including the information on the interval table to the terminal. The terminal may receive the other configuration information including the information on the interval table from the base station.

As another example, the base station may transmit, to the terminal, information on a number of uniform range intervals for an interval table to be used when reporting a difference (SGCS1-SGCS2) or (SGCS2-SGCS1) obtained by subtracting the smaller SGCS value from the larger SGCS value. The number of uniform range intervals may be information indicating, to the terminal, into how many intervals a range between 0 and 1 is uniformly divided.

The base station may transmit CSI report configuration information (e.g. CSI-ReportConfig) including the information on the number of uniform range intervals for the interval table to the terminal. The terminal may receive the CSI report configuration information (e.g. CSI-ReportConfig) including the information on the number of uniform range intervals for the interval table from the base station. The base station may transmit UAI including the information on the number of uniform range intervals for the interval table to the terminal.

The terminal may receive the UAI including the information on the number of uniform range intervals for the interval table from the base station. Alternatively, the base station may transmit other configuration information (e.g. OtherConfig) including the information on the number of uniform range intervals for the interval table to the terminal. The terminal may receive the other configuration information including the information on the number of uniform range intervals for the interval table from the base station. The terminal may generate the interval table based on the number of uniform range intervals for the interval table.

As another example, the base station may transmit, to the terminal, information on a range interval size for an interval table to be used when reporting a difference (SGCS1-SGCS2) or (SGCS2-SGCS1) obtained by subtracting the smaller SGCS value from the larger SGCS value. The range interval size may be information indicating, to the terminal, an interval used to uniformly divide a range between 0 and 1. The base station may transmit CSI report configuration information (e.g. CSI-ReportConfig) including the information on the range interval size for the interval table to the terminal.

The terminal may receive the CSI report configuration information (e.g. CSI-ReportConfig) including the information on the range interval size for the interval table from the base station. The base station may transmit UAI including the information on the range interval size for the interval table to the terminal. The terminal may receive the UAI including the information on the range interval size for the interval table from the base station. Alternatively, the base station may transmit other configuration information (e.g. OtherConfig) including the information on the range interval size for the interval table to the terminal. The terminal may receive the other configuration information including the information on the range interval size for the interval table from the base station. The terminal may generate the interval table based on the range interval size for the interval table.

The terminal may identify a range interval in the interval table to which a difference (SGCS1-SGCS2) or (SGCS2-SGCS1) obtained by subtracting the smaller SGCS value from the larger SGCS value belongs, and may report an interval number or an interval index corresponding to the identified range interval to the base station. The number of range intervals of the interval table may be n, and n may be a natural number. In this case, the terminal may report the interval number or the interval index to the base station using ceil(log₂ n) bits. A CEIL function may return a next integer value by always rounding up a specified value when the specified value includes a decimal part. The base station may receive the interval number or the interval index corresponding to the identified range interval from the terminal.

When the terminal reports the difference between the first SGCS and the second SGCS to the base station, the base station may configure, for the terminal through an RRC parameter or the like, range intervals for the difference (SGCS1-SGCS2) or (SGCS2-SGCS1). For example, the base station may transmit, to the terminal, information on an interval table to be used when reporting the difference (SGCS1-SGCS2) or (SGCS2-SGCS1). The base station may transmit CSI report configuration information (e.g. CSI-ReportConfig) including the information on the interval table to the terminal.

The terminal may receive the CSI report configuration information (e.g. CSI-ReportConfig) including the information on the interval table from the base station. The base station may transmit UAI including the information on the interval table to the terminal. The terminal may receive the UAI including the information on the interval table from the base station. Alternatively, the base station may transmit other configuration information (e.g. OtherConfig) including the information on the interval table to the terminal. The terminal may receive the other configuration information including the information on the interval table from the base station.

As another example, the base station may transmit, to the terminal, information on the number of uniform range intervals for an interval table to be used when reporting the difference (SGCS1-SGCS2) or (SGCS2-SGCS1). The number of uniform range intervals may be information indicating, to the terminal, into how many intervals a range between −1 and 1 is uniformly divided.

The base station may transmit CSI report configuration information (e.g. CSI-ReportConfig) including the information on the number of uniform range intervals for the interval table to the terminal. The terminal may receive the CSI report configuration information (e.g. CSI-ReportConfig) including the information on the number of uniform range intervals for the interval table from the base station. The base station may transmit UAI including the information on the number of uniform range intervals for the interval table to the terminal.

The terminal may receive the UAI including the information on the number of uniform range intervals for the interval table from the base station. Alternatively, the base station may transmit other configuration information (e.g. OtherConfig) including the information on the number of uniform range intervals for the interval table to the terminal. The terminal may receive the other configuration including the information on the number of uniform range intervals for the interval table from the base station. The terminal may generate the interval table based on the number of uniform range intervals for the interval table.

As another example, the base station may transmit, to the terminal, information on a range interval size for an interval table to be used when reporting the difference (SGCS1-SGCS2) or (SGCS2-SGCS1). The range interval size may be information indicating, to the terminal, an interval use to uniformly divide a range between −1 and 1.

The base station may transmit CSI report configuration information (e.g. CSI-ReportConfig) including the information on the range interval size for the interval table to the terminal. The terminal may receive the CSI report configuration information (e.g. CSI-ReportConfig) including the information on the range interval size for the interval table from the base station. The base station may transmit UAI including the information on the range interval size for the interval table to the terminal. The terminal may receive the UAI including the information on the range interval size for the interval table from the base station. Alternatively, the base station may transmit other configuration information (e.g. OtherConfig) including the information on the range interval size for the interval table to the terminal. The terminal may receive the other configuration information including the information on the range interval size for the interval table from the base station. The terminal may generate the interval table based on the range interval size for the interval table.

The terminal may identify a range interval in the interval table to which the difference (SGCS1-SGCS2) or (SGCS2-SGCS1) belongs, and may report an interval number or an interval index corresponding to the identified range interval to the base station. The number of range intervals in the interval table may be n, and n may be a natural number. In this case, the terminal may report the interval number or the interval index to the base station using ceil(log₂ n) bits. A CEIL function may return a next integer value by always rounding up a specified value when the specified value includes a decimal part. The base station may receive the interval number or the interval index corresponding to the identified range interval from the terminal.

When the terminal reports both SGCS1 and SGCS2 to the base station, the terminal may report SGCS1 and SGCS1-SGCS2 (or SGCS2-SGCS1) to the base station. The base station may receive SGCS1 and SGCS1-SGCS2 (or SGCS2-SGCS1) from the terminal. When the terminal reports both SGCS1 and SGCS2 to the base station, the terminal may report SGCS2 and SGCS1-SGCS2 (or SGCS2-SGCS1) to the base station. The base station may receive SGCS2 and SGCS1-SGCS2 (or SGCS2-SGCS1) from the terminal.

When the terminal reports a performance metric for an AI/ML model to the base station, the terminal may report the performance metric to the base station through UCI or layer 1 (L1) signaling. The base station may receive the performance metric for the AI/ML model from the terminal through UCI or L1 signaling. In this case, the base station may set a priority for UCI multiplexing in a PUCCH or a PUSCH in the order of HARQ-ACK>scheduling request>performance metric>CSI.

The base station may define the performance metric as a CSI reporting field for the reported performance metric and may set a priority of performance metric reporting higher than other CSI reporting. When a CSI inference result of the AI/ML model is packed in UCI and transmitted, the terminal may preferentially transmit a model performance monitoring result of the AI/ML model over a CSI inference result to be packed when the performance of the AI/ML model is degraded. As a result, the base station may restrict the use of an AI/ML model with degraded performance at the terminal. Consequently, the network may instruct the terminal to perform switching of the AI/ML model or fallback to a legacy mode. The base station may prepare for potential system performance degradation.

When the terminal reports a performance metric for an AI/ML model for CSI prediction to the base station, the terminal may report the performance metric to the base station through UCI or L1 signaling. The base station may receive the performance metric for the AI/ML model for CSI prediction from the terminal through UCI or L1 signaling. In this case, the performance metric may be classified into one of multiple CSI categories. When the terminal reports the performance metric to the base station, the terminal may not report other types of legacy CSI (e.g. CQI, RI, or PMI) together to the base station. When the terminal should simultaneously report a performance metric for an AI/ML model for CSI prediction and a performance metric for an AI/ML model for beam management to the base station, the terminal may sequentially report to the base station according to a configured reporting priority. The base station may sequentially receive the performance metric for the AI/ML model for CSI prediction and the performance metric for the AI/ML model for beam management from the terminal.

In the CSI prediction process using the AI/ML model, the fourth step for model monitoring may be determining an operation of a UE-sided AI/ML model at the base station based on a report result of the terminal. In this step, the base station may instruct the terminal to perform switching, deactivation, or fallback of the AI/ML model using DCI. Alternatively, in this step, the base station may instruct the terminal to perform switching, deactivation, or fallback of the AI/ML model using an RRC parameter. Alternatively, in this step, the base station may instruct the terminal to perform switching, deactivation, or fallback of the AI/ML model using functionality-based LCM. The base station may instruct the terminal to perform switching, activation, deactivation, or fallback of the AI/ML model using DCI. The base station may instruct the terminal in a UE-specific manner. The base station may instruct operations such as switching, deactivation, or fallback of the AI/ML model by using additional 2 bits in DCI. The base station may instruct the terminal to perform switching, deactivation, or fallback of the AI/ML model using an RRC parameter or the like. The base station may instruct the operation to the terminal in a UE-specific manner. The base station may instruct the terminal to perform switching, deactivation, or fallback of the AI/ML model using other configuration information (e.g. OtherConfig). The terminal may receive an operation instruction from the base station and may perform an operation according to the received operation instruction.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, the method comprising:
receiving, from a base station, a reporting instruction for performance metrics;
determining a first performance metric based on first channel state information (CSI) at a first time and second CSI predicted for the first time;
determining a second performance metric based on the first CSI and third CSI at a second time; and
transmitting, to the base station, the first performance metric and the second performance metric according to the reporting instruction.

2. The method of claim 1, wherein the determining of the first performance metric comprises:
receiving, from the base station, a first reference signal (RS) before the first time;
determining fourth CSI based on the first RS;
predicting the second CSI using an artificial intelligence (AI)/machine learning (ML) model based on the determined fourth CSI;
receiving, from the base station, a second RS at the first time;
determining the first CSI based on the second RS; and
determining the first performance metric based on the first CSI and the second CSI.

3. The method of claim 2, wherein the first CSI comprises first subband CSIs measured for respective subbands, and the second CSI comprises second subband CSIs predicted for the respective subbands, and the determining of the first performance metric based on the first CSI and the second CSI comprises:
determining first subband performance metrics for the respective subbands based on the first subband CSIs and the second subband CSIs; and
determining an average of the first subband performance metrics as the first performance metric.

4. The method of claim 2, wherein the first CSI comprises first layer CSIs measured for respective layers, and the second CSI comprises second layer CSIs predicted for the respective layers, and the determining of the first performance metric based on the first CSI and the second CSI comprises:
determining first layer performance metrics for the respective layers based on the first layer CSIs and the second layer CSIs; and
determining the first layer performance metrics as the first performance metric.

5. The method of claim 1, wherein the determining of the second performance metric based on the first CSI and the third CSI at the second time comprises:
receiving, from the base station, a third RS at the second time;
determining the third CSI based on the third RS; and
determining the second performance metric based on the first CSI and the third CSI.

6. The method of claim 5, wherein the third RS is received in one CSI-RS transmission occasion among CSI-RS transmission occasions earlier than a CSI-RS for CSI prediction reporting.

7. The method of claim 1, wherein the transmitting of the first performance metric and the second performance metric to the base station according to the reporting instruction comprises:
determining a first interval index of a first performance metric interval including the first performance metric in a performance metric interval table configured with performance metric intervals and interval indices;
determining a second interval index of a second performance metric interval including the second performance metric in the performance metric interval table; and
transmitting the first interval index and the second interval index to the base station.

8. The method of claim 1, wherein the first performance metric represents a similarity between a first precoder corresponding to a first precoding matrix indicator (PMI) of the first CSI and a second precoder corresponding to a second PMI of the second CSI, and the second performance metric represents a similarity between the first precoder and a third precoder corresponding to a third PMI of the third CSI.

9. A method of a base station, the method comprising:
transmitting, to a terminal, a reporting instruction for performance metrics;
transmitting, to the terminal, a first reference signal (RS) before a first time;
transmitting, to the terminal, a second RS at the first time;
transmitting, to the terminal, a third RS at a second time;
receiving, from the terminal, a first performance metric and a second performance metric based on the first to third RSs,
wherein the first performance metric is determined based on first channel state information (CSI) of the second RS and second CSI predicted for the first time using an artificial intelligence (AI)/machine learning (ML) model based on the first RS, and the second performance metric is determined based on the first CSI and third CSI of the third RS.

10. The method of claim 9, wherein the first CSI comprises first subband CSIs measured for respective subbands, and the second CSI comprises second subband CSIs predicted for the respective subbands, and the first performance metric is an average of first subband performance metrics for the respective subbands determined based on the first subband CSIs and the second subband CSIs.

11. The method of claim 9, wherein the first CSI comprises first layer CSIs measured for respective layers, and the second CSI comprises second layer CSIs predicted for the respective layers, and the first performance metric comprises first layer performance metrics for the respective layers determined based on the first layer CSIs and the second layer CSIs.

12. The method of claim 9, wherein the third RS is transmitted based on one CSI-RS transmission occasion among CSI-RS transmission occasions earlier than a CSI-RS for CSI prediction reporting.

13. The method of claim 9, wherein the first performance metric is indicated by a first interval index of a first performance metric interval including the first performance metric in a performance metric interval table configured with performance metric intervals and interval indices, and the second performance metric is indicated by a second interval index of a second performance metric interval including the second performance metric in the performance metric interval table.

14. The method of claim 9, wherein the first performance metric represents a similarity between a first precoder corresponding to a first precoding matrix indicator (PMI) of the first CSI and a second precoder corresponding to a second PMI of the second CSI, and the second performance metric represents a similarity between the first precoder and a third precoder corresponding to a third PMI of the third CSI.

15. A terminal comprising at least one processor, wherein the at least one processor causes the terminal to perform:
receiving, from a base station, a reporting instruction for performance metrics;
determining a first performance metric based on first channel state information (CSI) at a first time and second CSI predicted for the first time;
determining a second performance metric based on the first CSI and third CSI at a second time; and
transmitting, to the base station, the first performance metric and the second performance metric according to the reporting instruction.

16. The terminal of claim 15, wherein in the determining of the first performance metric, the at least one processor causes the terminal to perform:
receiving, from the base station, a first reference signal (RS) before the first time;
determining fourth CSI based on the first RS;
predicting the second CSI using an artificial intelligence (AI)/machine learning (ML) model based on the determined fourth CSI;
receiving, from the base station, a second RS at the first time;
determining the first CSI based on the second RS; and
determining the first performance metric based on the first CSI and the second CSI.

17. The terminal of claim 15, wherein the first CSI comprises first subband CSIs measured for respective subbands, and the second CSI comprises second subband CSIs predicted for the respective subbands, and in the determining of the first performance metric based on the first CSI and the second CSI, the at least one processor causes the terminal to perform:
determining first subband performance metrics for the respective subbands based on the first subband CSIs and the second subband CSIs; and
determining an average of the first subband performance metrics as the first performance metric.

18. The terminal of claim 15, wherein the first CSI comprises first layer CSIs measured for respective layers, and the second CSI comprises second layer CSIs predicted for the respective layers, and in the determining of the first performance metric based on the first CSI and the second CSI, the at least one processor causes the terminal to perform:
determining first layer performance metrics for the respective layers based on the first layer CSIs and the second layer CSIs; and
determining the first layer performance metrics as the first performance metric.

19. The terminal of claim 15, wherein in the transmitting of the first performance metric and the second performance metric to the base station according to the reporting instruction, the at least one processor causes the terminal to perform:
determining a first interval index of a first performance metric interval including the first performance metric in a performance metric interval table configured with performance metric intervals and interval indices;
determining a second interval index of a second performance metric interval including the second performance metric in the performance metric interval table; and
transmitting the first interval index and the second interval index to the base station.

20. The terminal of claim 15, wherein the first performance metric represents a similarity between a first precoder corresponding to a first precoding matrix indicator (PMI) of the first CSI and a second precoder corresponding to a second PMI of the second CSI, and the second performance metric represents a similarity between the first precoder and a third precoder corresponding to a third PMI of the third CSI.
